(19) United States
(12) Patent Application Publication
(10) Pub. No.: US 2012/0046409 A1
(43) Pub. Date: Feb. 23, 2012

(54) HYBRID DISPERSIONS AND METHODS FOR PRODUCING THE SAME

(75) Inventors: Christian Piechocki, Marienthal (FR); John N. Argyropoulos, Midland, MI (US); Robert R. Bills, Midland, MI (US); Ray E. Drumright, Midland, MI (US)

(73) Assignee: Dow Global Technologies LLC, Midland, MI (US)

(21) Appl. No.: 13/262,547

(22) PCT Filed: Feb. 22, 2010
(86) PCT No.: PCT/US10/24907

§ 371 Date: Oct. 26, 2011

Related U.S. Application Data
(60) Provisional application No. 61/164,692, filed on Mar. 30, 2009.

(51) Int. Cl. C09D 175/04

(52) U.S. Cl. 524/507

(57) ABSTRACT

The instant invention is a hybrid dispersion, method of producing the same, articles made therefrom, and method of making such articles. The hybrid dispersion according to the present invention comprises the blending product of: (a) less than 30 percent by weight of a minor component comprising a hydrophobic polyurethane dispersion derived from one or more natural oil based polyols, based on the weight of the hybrid dispersion; and (b) less than 100 percent by weight of a major component selected from the group consisting of a latex emulsion, an epoxy, and a polyolefin dispersion; wherein the hybrid dispersion has a solid content in the range of 10 to 75 percent based on the weight of the hybrid dispersion.

### CROSS-REFERENCE TO RELATED APPLICATIONS

This application is a non-provisional application claiming priority from the U.S. Provisional Patent Application No. 61/164,692 filed on Mar. 30, 2009, entitled “HYBRID DISPERSIONS AND METHODS FOR PRODUCING THE SAME,” the teachings of which are incorporated by reference herein, as if reproduced in full hereinbelow.

### FIELD OF INVENTION

The instant invention relates to hybrid dispersions, methods for producing the same, coated articles and structures, and methods for coating articles and structures.

### BACKGROUND OF THE INVENTION

The use of dispersions in coating applications is generally known. Different techniques may be employed to produce such dispersions suitable for coating applications.

U.S. Pat. No. 6,635,706 describes a pre-crosslinked, urethane-acrylic dispersion formed from an isocyanate terminated urethane prepolymer reacted with mono-functional active hydrogen containing vinyl monomer and vinyl monomers inert to isocyanate functionality. To this polyurethane prepolymer having 0 to 100 percent vinyl termination-vinyl monomer blend is added a polyisocyanate having an average isocyanate functionality of less than 4 such that 0.5 to 20 percent of the urethane solids of the blend are polyisocyanate. The mixture containing less than 3 percent NCO groups, on solids, is dispersed into water and any residual isocyanate groups chain extended with one or more active hydrogen containing compounds. Optionally, the polyisocyanate can be added directly into the dispersion once the polyurethane prepolymer and the vinyl monomer blend is dispersed. The vinyl monomers are then reacted by free radical polymerization.

U.S. Pat. No. 6,063,861 describes an aqueous polyurethane-polyacrylate hybrid dispersions, which are self crosslinkable at room temperature and contain (A) 10 to 95 percent by weight of a polyurethane dispersion, (B) 5 to 90 percent by weight of a polymer prepared in the presence of component (A) from a mixture of vinyl monomers containing 0.5 to 20 weight percent, based on the total resin solids content of the hybrid dispersion, of a vinyl monomer containing acetoacetoxy groups; and (C) an at least one di-functional primary or secondary amine.

U.S. Patent Publication No. 2007/0141264 describes an aqueous coating composition comprising 20 to 80 percent by weight of a polyurethane with an acid value of 8 to 40 mg KOH/g and a hard segment content of ≧40 weight percent, a ring structure content≧48 weight percent; and 80 to 20 percent by weight of a vinyl polymer B with a Tg≧20° C.

International Publication Number WO 2004/096882 describes polyols useful in the manufacture of polyurethanes. The polyols are prepared by reacting a vegetable oil based (hydroxymethyl containing) monomer with a polyol, polyamine or aminoalcohol under vacuum.

International Publication Number WO 2006/047431 describes polymer dispersions, which are prepared by reaction of a polyisocyanate and a hydroxylmethyl containing polyester polyol derived from a fatty acid to form a prepolymer, dispersing the prepolymer in an aqueous phase and then curing the prepolymer to form solid particle particles. The prepolymers can be prepared having isocyanate, hydroxyl, or a variety of other reactive functional groups.

Despite the research efforts in developing dispersion suitable for coating applications, there is still a need for a hybrid dispersion having improved properties such as dirt-pickup-resistance properties, stain and block resistance properties, and low water pick-up properties, which may be used in coating applications such as industrial coating applications. There is further a need for a method of producing such hybrid dispersions.

### SUMMARY OF THE INVENTION

The instant invention provides hybrid dispersions, methods for producing the same, coated articles and structures, and methods for coating articles and structures. The hybrid dispersions according to the present invention comprise the blending product of: (a) less than 30 percent by weight of a minor component comprising a hydrophobic polyurethane dispersion derived from one or more natural oil based polyols, based on the weight of the hybrid dispersion; and (b) less than 100 percent by weight of a major component selected from the group consisting of a latex emulsion, an epoxy, and a polyolefin dispersion. The hybrid dispersion has a solid content in the range of 10 to 75 percent based on the weight of the hybrid dispersion. The process for producing a hybrid dispersion comprises the steps of: (1) selecting a minor component comprising a hydrophobic polyurethane dispersion derived from one or more natural oil based polyols; (2) selecting a major component selected from the group consisting of a latex emulsion, an epoxy, and a polyolefin dispersion; (3) blending the minor component into the major component; (4) thereby producing the hybrid dispersion. The coated articles or structures according to the present invention comprise a coating layer associated with one or more surfaces of an article or a structure, wherein said coating layer is derived from the inventive hybrid dispersion according to the present invention. The method for coating articles or structures comprises the steps of (1) selecting the inventive hybrid dispersion (2) applying the hybrid dispersion to one or more surfaces of an article or a structure; (3) removing at least a portion of water from the hybrid dispersion associated with one or more surfaces of the article or structure; and (4) thereby coating the article or structure.

### DETAILED DESCRIPTION OF THE INVENTION

The instant invention provides hybrid dispersions, methods for producing the same, coated articles and structures, and methods for coating articles and structures.

The hybrid dispersion according to the present invention comprises the blending product of: (a) less than 30 percent by weight of a minor component comprising a hydrophobic polyurethane dispersion derived from one or more natural oil based polyols, based on the weight of the hybrid dispersion; and (b) less than 100 percent by weight of a major component selected from the group consisting of a latex emulsion, an epoxy, and a polyolefin dispersion. The hybrid dispersion has a solid content in the range of 10 to 75 percent based on the weight of the hybrid dispersion.

The hybrid dispersion may comprise from less than 30 percent by weight a minor component, as described hereinbelow in further details, based on the weight of the hybrid dispersion. All individual values and subranges from less than 30 weight percent are included herein and disclosed herein; for example, the weight percent of the minor component can be from a lower limit of 0.5, 1, 2, 3, 5, 10, 15, 20, or 25 weight percent to an upper limit of 5, 10, 15, 20, 25, or less than 30 weight percent. For example, the hybrid dispersion may comprise from 3 to 25 percent, or 5 to 25 percent, or 5 to 20 percent, or 5 to 15 percent, or 0.5 to 25 percent, or 0.5 to 25 percent by weight of the minor component, based on the weight of the hybrid dispersion.

The hybrid dispersion may comprise from less than 100 percent by weight a major component, as described hereinbelow in further details, based on the weight of the hybrid dispersion. All individual values and subranges from less than 100 weight percent are included herein and disclosed herein; for example, the weight percent of the major component can be from a lower limit of 5, 10, 15, 20, 25, 50, 70, 75, 80, 85, 90, or 95 weight percent to an upper limit of 50, 70, 75, 80, 85, 90, 95 or less than 100 weight percent. For example, the hybrid dispersion may comprise from 5 to 95 percent, or 5 to 90 percent, or 5 to 85 percent, or 5 to 80 percent, or 5 to 75 percent, or 5 to 70 percent by weight of the major component, based on the weight of the hybrid dispersion.

The hybrid dispersion may comprise at least 5 percent by weight of solid content, excluding the weight of any filler, based on the total weight of the hybrid dispersion. All individual values and subranges of at least 5 weight percent are included herein and disclosed herein; for example, the weight percent can be from a lower limit of 5,10,20, 30, 40, 50, 55, 60, 65, 70, 75, or 80 weight percent to an upper limit of 45, 50, 55, 60, 65, 70, 75, 80 or 85 weight percent. For example, the hybrid dispersion may comprise at least 10 percent, or at least 20 percent, or at least 30 percent, or at least 40 percent, or at least 45 percent, or at least 50 percent, or at least 55 percent, or at least 60 percent, or at least 65 percent, or at least 70 percent by weight of solid content, excluding the weight of any filler, based on the total weight of the hybrid dispersion.

In one embodiment, the hybrid dispersion may comprise 1 to 25 percent by the dry weight of the solid content of the hydrophobic polyurethane dispersion, based on the total solid content of the hybrid dispersion. All individual values and subranges from 1 to 25 dry weight percent are included herein and disclosed herein; for example, the dry weight percent can be from a lower limit of 1, 2, 3, 4, 5, 10 or 15 weight percent to an upper limit of 10, 12, 15, 18, 20, 22, or 25 weight percent. For example, hybrid dispersion may comprise 1 to 20, or 5 to 20, or 10 to 15, or 10 to 20 percent by the dry weight of the solid content of the hydrophobic polyurethane dispersion, based on the total solid content of the hybrid dispersion.

In another embodiment, the hybrid dispersion may comprise 1 to 25 percent by the dry weight of one or more hydrophobic polyurethane prepolymers, based on the total solid content of the hybrid dispersion. All individual values and subranges from 1 to 25 dry weight percent are included herein and disclosed herein; for example, the dry weight percent can be from a lower limit of 1, 2, 3, 4, 5, 10 or 15 weight percent to an upper limit of 10, 12, 15, 18, 20, 22, or 25 weight percent. For example, hybrid dispersion may comprise 1 to 20, or 5 to 20, or 10 to 15 or 10 to 20 percent by the dry weight of one or more hydrophobic polyurethane prepolymers, based on the total solid content of the hybrid dispersion.

The hybrid dispersion according to the present invention is a film forming composition. The film derived from the inventive hybrid dispersion may have a dirt pick-up resistance in the range of less than 45 percent drop in reflectance; in the alternative, less than 40 percent drop in reflectance; in the alternative, less than 37 percent drop in reflectance; in the alternative, less than 35 percent drop in reflectance. The film derived from the inventive hybrid dispersion may further have a water uptake in the range of less than 30 percent; in the alternative, less than 25 percent; in the alternative, less than 20 percent; in the alternative, less than 15 percent; in the alternative, less than 12 percent.

In one embodiment, the film derived from the inventive hybrid dispersion may have a block resistance rating in the range of at least above 5 measured at 25° C. after 24 hours. In alternative embodiment, the film derived from the inventive hybrid dispersion may have a block resistance rating in the range of 5 and above measured at 55° C. after 24 hours. In alternative embodiment, the film derived from the inventive hybrid dispersion may have a block resistance rating in the range of at least above 5 measured at 25° C. after 7 days. In alternative embodiment, the film derived from the inventive hybrid dispersion may have a block resistance rating in the range of 5 and above measured at 55° C. after 7 days.

The hybrid dispersion may further include one or more fillers, one or more pigments, one or more antifoam agents, one or more dispersant agents, one or more coalescing agents, one or more additional surfactants, one or more slip agents, and the like.

### Minor Component

The hybrid dispersion comprises less than 30 percent by weight of a minor component based on the weight of the hybrid dispersion. All individual values and subranges from less than 30 weight percent are included herein and disclosed herein; for example, the hybrid dispersion comprises from 1 to less than 30, or 1 to 20, or 1 to 15, or 1 to 10 percent by weight of the minor component, based on the weight of the hybrid dispersion. The minor component comprises a hydrophobic polyurethane dispersion derived from one or more natural oil based polyols. In the alternative, the minor component comprises a hydrophobic polyurethane prepolymer derived from one or more natural oil based polyols.

The hydrophobic polyurethane dispersion component may be prepared by forming an isocyanate-terminated prepolymer, dispersing the prepolymer in an aqueous phase, and then forming the polyurethane and/or urea polymer by chain-extending the prepolymer. The prepolymer itself is made by reacting an excess of a polyisocyanate with a polyol derived from one or more natural oil based polyols.

The polyurethane prepolymer derived from one or more natural oil based polyols used in the present invention may be produced by any conventionally known processes, for example, solution process, hot melt process, or polyurethane prepolymer mixing process, for example, in batch or continuous process. Furthermore, the polyurethane prepolymer derived from one or more natural oil based polyols may, for example, be produced via a process for reacting a polyisocyanate compound with an active hydrogen-containing compound, that is, one or more natural oil based polyols, and examples thereof include 1) a process for reacting a polyisocyanate compound with one or more natural oil based polyols without using an organic solvent, and 2) a process for reacting a polyisocyanate compound with one or more natural oil based polyols in an organic solvent, for example, N-Methylpyrrolidone (NMP), or Acetone, or Methyl Ethyl Ketone (MEK), PROGLYDE DMM (dipropylene glycol dimethyl ether, CAS No. 111109-77-4), followed optionally by removal of the solvent. In one embodiment, the polyurethane prepolymer is preferably derived from the reaction of a polyisocyanate compound with one or more natural oil based polyols, for example, seed oil derived polyol.

For example, the polyisocyanate compound may be reacted with one or more natural oil based polyols at a temperature in the range of 20° C. to 150° C.; or in the alternative, in the range of 30° C. to 130° C., at an equivalent ratio of an isocyanate group to an active hydrogen group of, for example, from 1.1:1 to 3:1, or in the alternative, from 1.2:1 to 2:1. In the alternative, the prepolymer may be prepared with an excess amount of one or more natural oil based polyols thereby facilitating the production of hydroxyl terminal polymers.

The natural oil based polyols are polyols based on or derived from renewable feedstock resources such as natural and/or genetically modified plant vegetable seed oils and/or animal source fats. Such oils and/or fats are generally comprised of triglycerides, that is, fatty acids linked together with glycerol. Examples include, but are not limited to, vegetable oils that have at least 70 percent unsaturated fatty acids in the triglyceride. The natural product may contain at least 85 percent by weight of unsaturated fatty acids. Exemplary vegetable oils include, but are not limited to, for example, those from castor, soybean, olive, peanut, rapeseed, corn, sesame, cotton, canola, safflower, linseed, palm, grapeseed, black caraway, pumpkin kernel, borage seed, wood germ, apricot kernel, pistachio, almond, macadamia nut, avocado, sea buckthorn, hemp, hazelnut, evening primrose, wild rose, thistle, walnut, sunflower, jatropha seed oils, or any combinations thereof. Additionally, oils obtained from organisms such as algae may also be used. Exemplary animal products include, but are not limited to, lard, beef tallow, fish oils and any mixtures or combinations thereof. A combination of vegetable and animal based oils/fats may also be used.

Several chemistries can be used to modify seed oils and seed oil esters in order to prepare the natural oil based polyols. Such modifications of a renewable resource include, but are not limited to, for example, epoxidation, hydroxylation, ozonolysis, esterification, hydroformylation, dimerization, or alkoxylation. Such modifications are commonly known in the art.

After the production of such polyols by modification of the natural oils, the modified products may be further alkoxylated. The use of ethylene oxide (EO) or mixtures of EO with other oxides, introduces hydrophilic moieties into the polyol. In one embodiment, the modified product undergoes alkoxylation with sufficient EO to produce a natural oil based polyol having an EO content in the range of 10 to 60 weight percent, for example, 20 to 40 weight percent.

In another embodiment, the natural oil based polyols are obtained by a multi-step process wherein the animal or vegetable oils/fats are subjected to transesterification and the constituent fatty acid esters recovered. This step is followed by hydroformylating carbon-carbon double bonds in the constituent fatty acid esters to form hydroxymethyl groups, and then forming a polyester or polyether/polyester by reaction of the hydroxymethylated fatty acid with an appropriate initiator compound. Such a multi-step process is commonly known in the art, and is described, for example, in the PCT Publication Nos. WO 2004/096882 and 2004/096883. The multi-step process results in the production of a polyol with both hydrophobic and hydrophilic moieties, which results in enhanced miscibility with both water and conventional petroleum-based polyols.

The initiator for use in the multi-step process for the production of the natural oil based polyols may be any initiator used in the production of conventional petroleum-based polyols. The initiator may, for example, be selected from the group consisting of neopentylglycol; 1,2-propylene glycol; trimethylolpropane; pentaerythritol; sorbitol; sucrose; glycerol; diethanolamine; alkanediols such as 1,6-hexanediol, 1,4-butanediol; 1,4-cyclohexane diol; 2,5-hexanediol; ethylene glycol; diethylene glycol, triethylene glycol; bis-3-aminopropyl methylamine; ethylene diamine; diethylene triamine; 9(1)-hydroxymethyloctadecanol, 1,4-bishydroxymethylcyclohexane; 8,8-bis(hydroxymethyl)tricyclo[5,2,1,0^{2,6}]decene; Dimerol alcohol (36 carbon diol available from Henkel Corporation); hydrogenated bisphenol; 9,9(10,10)-bishydroxymethyloctadecanol; 1,2,6-hexanetriol and combination thereof. In the alternative, the initiator may be selected from the group consisting of glycerol; ethylene glycol; 1,2-propylene glycol; trimethylolpropane; ethylene diamine; pentaerythritol; diethylene triamine; sorbitol; sucrose; or any of the aforementioned where at least one of the alcohol or amine groups present therein has been reacted with ethylene oxide, propylene oxide or mixture thereof; and combination thereof. In another alternative, the initiator is glycerol, trimethylopropane, pentaerythritol, sucrose, sorbitol, and/or mixture thereof.

In one embodiment, the initiators are alkoxlyated with ethylene oxide or a mixture of ethylene oxide and at least one other alkylene oxide to give an alkoxylated initiator with a molecular weight in the range of from 200 to 6000, for example, in the range of from 500 to 3000.

The functionality of the at least one natural oil based polyol, is above about 1.5 and generally not higher than about 6. In one embodiment, the functionality is below about 4. In one embodiment the functionality is in the range of from 1.5 to 3. In one embodiment the functionality is in the range of from 1.5 to 2.2, for example, 2. The hydroxyl number of the at least one natural oil based polyol is below 300 mg KOH/g; for example, in the range of from 50 and 300; or in the alternative, in the range of from 60 to 200; or in the alternative, in the range of less than 100.

The level of renewable feedstock in the natural oil based polyol can be from 10 to 100 percent; for example, from 10 to 90 percent.

The natural oil based polyols may constitute up to 90 weight percent of a polyol blend. However, in one embodiment, the natural oil based polyol may constitute at least 5 weight percent, at least 10 weight percent, at least 25 weight percent, at least 35 weight percent, at least 40 weight percent, at least 50 weight percent, or at least 55 weight percent of the total weight of the polyol blend. The natural oil based polyols may constitute 40 percent or more, 50 weight percent or more, 60 weight percent or more, 75 weight percent or more, 85 weight percent or more, 90 weight percent or more, or 95 weight percent or more of the total weight of the combined polyols. Combination of two types or more of natural oil based polyols may also be used.

The viscosity measured at 25° C. of the natural oil based polyols is generally less than 6,000 mPa·s; for example, the viscosity measured at 25° C. of the natural oil based polyols is less than 5,000 mPa·s.

The natural oil based polyol may also be blended with one or more polyols including, but not limited to, aliphatic and/or aromatic polyester polyols including caprolactone based polyester polyols, any polyester/polyether hybrid polyols, PTMEG-based polyether polyols; polyether polyols based on ethylene oxide, propylene oxide, butylene oxide and mixtures thereof; polycarbonate polyols; polyacetal polyols, polyacrylate polyols; polyesteramide polyols; polythioether polyols; polyolefin polyols such as saturated or unsaturated polybutadiene polyols. The natural oil based polyol may also be blended with one or more short chain diols, one or more molecules that bear ionic centers such as dimethylol propionic acid; dimethylol butonic acid.

Examples of the polyisocyanate compound include 2,4-tolylene diisocyanate, 2,6-tolylene diisocyanate, m-phenylene diisocyanate, p-phenylene diisocyanate, 4,4′-diphenylmethane diisocyanate, 2,4′-diphenylmethane diisocyanate, 2,2′-diphenylmethane diisocyanate, 3,3′-dimethyl-4,4′-biphenylene diisocyanate, 3,3′-dimethoxy-4,4′-biphenylene diisocyanate, 3,3′-dichloro-4,4′-biphenylene diisocyanate, 1,5-naphthalene diisocyanate, 1,5-tetrahydronaphthalene diisocyanate, tetramethylene diisocyanate, 1,6-hexamethylene diisocyanate, dodecamethylene diisocyanate, trimethylhexamethylene diisocyanate, 1,3 and 1,4-bis(isocyanatemethyl) cyclohexane, xylylene diisocyanate, tetramethylxylylene diisocyanate, hydrogenated xylylene diisocyanate, lysine diisocyanate, isophorone diisocyanate, 4,4′-dicyclohexylmethane diisocyanate, 3,3′-dimethyl-4,4′-dicyclohexylmethane diisocyanate, isomers thereof, and/or combinations thereof.

The polyurethane prepolymer derived from natural oil based polyols could be prepared in the presence of one or more reactive or un-reactive ethylenically unsaturated monomers. Such monomers may further be polymerized.

The polyurethane prepolymer derived from natural oil based polyols may further include a hydrophilic group. The term “hydrophilic group,” as used herein, refers to an anionic group (for example, carboxyl group, sulfonic acid group, or phosphoric acid group), or a cationic group (for example, tertiary amino group, or quaternary amino group), or a nonionic hydrophilic group (for example, a group composed of a repeating unit of ethylene oxide, or a group composed of a repeating unit of ethylene oxide and a repeating unit of another alkylene oxide).

Among hydrophilic groups, a nonionic hydrophilic group having a repeating unit of ethylene oxide may, for example, be used. Introduction of a carboxyl group and/or a sulfonic acid group may be effective to make the particle size finer.

When the ionic group is an anionic group, the neutralizer used for neutralization includes, for example, nonvolatile bases such as sodium hydroxide and potassium hydroxide; and volatile bases such as tertiary amines (for example, trimethylamine, triethylamine, dimethylethanolamine, methyldiethanolamine, and triethanolamine) and ammonia can be used.

When the ionic group is a cationic group, usable neutralizer includes, for example, inorganic acids such as hydrochloric acid, sulfuric acid, and nitric acid; and organic acids such as formic acid and acetic acid.

Neutralization may be conducted before, during or after the polymerization of the polyurethane prepolymer derived from natural oil based polyols having an ionic group. The neutralization may be affected by adding the neutralizing agent directly to the polyurethane prepolymer derived from natural oil based polyols or by adding to the aqueous phase during the production of polyurethane dispersion.

Polyurethane prepolymers are typically chain extended via a chain extender. Any chain extender known to be useful to those of ordinary skill in the art of preparing polyurethanes can be used with the present invention. Such chain extenders typically have a molecular weight in the range of from 18 to 500 and have at least two active hydrogen containing groups. Polyamines are an exemplary class of chain extenders. Other materials, particularly water, can function to extend chain length and so are chain extenders for purposes of the present invention. It is particularly preferred that the chain extender is water or a mixture of water and an amine such as, for example, aminated polypropylene glycols such as JEFFAMINE D-400 from Huntsman Chemical Company, amino ethyl piperazine, 2-methyl piperazine, 1,5-diamino-3-methyl-pentane, isophorone diamine, ethylene diamine, diethylene triamine, triethylene tetramine, triethylene pentamine, ethanol amine, lysine in any of its stereoisomeric forms and salts thereof, hexane diamine, hydrazine and piperazine. In the practice of the present invention, the chain extender may be used as a solution of chain extender in water.

The polyurethane dispersion may be produced via a batch process or a continuous process. Polyurethane prepolymer derived from natural oil based polyols, optionally a surfactant, and water are fed into a mixer, for example, an OAKS mixer or an IKA mixer, thereby dispersing the polyurethane prepolymer derived from natural oil based polyols into the water. Subsequently, the dispersed polyurethane prepolymers derived from natural oil based polyols are chain extended with one or more primary or secondary amine to form the polyurethane dispersion.

In one embodiment, the aqueous polyurethane dispersion is made by mixing the prepolymer derived from natural oil based polyols with water, optionally in the presence of a surfactant or other additive and/or phase modifier and/or a chain extender, at a temperature of from 25 to 90° C., to render the desired polyurethane dispersion. The amount of water, and optional chain extender, reacted with the prepolymer is an equivalent amount to the isocyanate functionality in the prepolymer derived from natural oil based polyols. An excess of water may also be used.

In addition to chain extenders, one or more surfactants may be included in the water phase. The surfactant may be anionic, ionic, cationic or zwitterionic or a mixture of monionic with cationic, anionic or zwitterionic. Preferred are nonionic and anionic surfactants. The surfactant, which is not incorporated into the polymer backbone, is selected from the group consisting of metal or ammonia salts of sulfonates, phosphates and carboxylates. Suitable surfactants include alkali metal salts of fatty acids such as sodium stearate, sodium palmitate, potassium oleate, alkali metal salts of fatty acid sulfates such as sodium lauryl sulfate, the alkali metal salts of alkylbenzenesulfones and alkylnaphthalenesulfones such as sodium dodecylbenzenesulfonate, sodium alkylnaphthalene-sulfonate; the alkali metal salts of dialkyl-sulfosuccinates; the alkali metal salts of sulfated alkylphenol ethoxylates such as sodium octylphenoxypolyethoxyethyl sulfate; the alkali metal salts of polyethoxyalcohol sulfates and the alkali metal salts of polyethoxyalkylphenol sulfates. More preferably, the anionic surfactant is sodium dodecyl benzene sulfonate, sodium dodecyl sulfonate, sodium dodecyl diphenyl oxide disulfonate, sodium n-decyl diphenyl oxide disulfonate, isopropylamine dodecylbenzenesulfonate, or sodium hexyl diphenyl oxide disulfonate, and most preferably, the anionic surfactant is sodium dodecyl benzene sulfonate. Preferred nonionic surfactants are ethylene oxide adducts of phenols, such as nonyl phenol. When present, the surfactant typically contains from 0.1 to 6 weight percent of the polyurethane dispersion, most preferably from 0.5 to 4 weight percent. In general, it is desired to add a sufficient amount of surfactant so as to render a dispersion having an average particle size wherein 50 and 1000 nm and a polydispersity of from 1.0 to 2.0. Further, if the prepolymer is self-emulsifying by inclusion of emulsifying nonionic, cationic, or anionic groups, then an external surfactant may or may not be necessary.

### Major Component

The major component is selected from the group consisting of a latex emulsion, an epoxy dispersion, a polyolefin dispersion, and combinations thereof.

### Emulsion Polymer Latex

The major component may comprise an emulsion polymer latex. Such emulsion polymer latex may comprise at least one synthetic latex. A synthetic latex is generally known as an aqueous dispersion of polymer particles prepared by emulsion polymerization of one or more monomers. The latex can have a monomodal or polymodal, for example, bimodal, particle size distribution. Mixtures or blends of latexes can be employed.

In one embodiment of the invention, the polymer of the latex is a copolymer, that is, a polymer formed from at least 2 monomers. The latex may contain a single copolymer or more than one copolymer. Advantageously, the polymer of the latex has a glass transition temperature (Tg) of from −50° C. to 100° C.

The copolymers that are useful alone, as opposed to those useful only in a blend, in the practice of this invention desirably have a Tg of no lower than about −10° C., preferably at least about 0° C. Desirably, the Tg of the copolymer is no higher than about 50° C., preferably up to about 40° C. The generally preferred range is from 0° C. to 40° C. The Tg of the copolymer of the composition of this invention is determined by differential scanning calorimetry (DSC).

While a wide range of monomeric compositions are useful for the latex component of major component of this invention, in a particular embodiment it is preferred that the copolymer is uncrosslinked by virtue of there being no crosslinking monomers present in the group of ethylenically unsaturated monomers present in the polymerization mixture from which it is prepared. That is, it is desirable in this embodiment that the copolymer be produced by polymerization in the absence of crosslinking monomers or some other crosslinking agent.

In an alternative embodiment, it is desirable for the copolymer to be lightly crosslinked. This may be accomplished by the inclusion in the polymerization mixture from which the copolymer is prepared of a monomer that is multifunctional and of known utility as a crosslinker, such as, for example, divinyl benzene or allyl (meth)acrylate. In this particular embodiment, it is preferred that the content of crosslinking monomers in the copolymer is no more than about 2 weight percent, preferably from 0.001 to 2 weight percent, more preferably from 0.01 to 1.5 weight percent, still more preferably from 0.1 to 1 weight percent, where the weight percentages are based on the total weight of monomers in the polymerization mixture.

A wide variety of monomers may be used to prepare copolymers suitable for use in the major component of this invention. (Meth)acrylate copolymers comprising primarily (meth)acrylate monomers are one desirable type of copolymer.

For the purposes of the emulsion polymer latex of the present invention, the term “(meth)” indicates that the methyl substituted compound is included in the class of compounds modified by that term. For example, the term (meth)acrylic acid represents acrylic acid and methacrylic acid.

With reference the emulsion polymer latex of the present invention, as used herein the term “(meth)acrylate copolymer” means a copolymer that contains in polymerized form at least 80 weight percent (meth)acrylate monomers and (meth)acrylic acid monomers. In a preferred embodiment, the copolymer contains in polymerized form at least 90 weight percent (meth)acrylate monomers and (meth)acrylic acid monomers, while even more preferred is the embodiment wherein the copolymer contains in polymerized form at least 95 weight percent (meth)acrylate monomers and (meth)acrylic acid monomers.

In a highly preferred embodiment, the copolymer is a pure (meth)acrylate, or a pure (meth)acrylate except for the inclusion of a non-(meth)acrylate seed therein. These copolymers desirably consist essentially of (meth)acrylate monomers, or of (meth)acrylate monomers and (meth)acrylic acid monomers.

With reference the emulsion polymer latex of the major component of the present invention, as used herein the term “(meth)acrylate monomers” is meant to include those monomers that are used to prepare the (meth)acrylate copolymers that are suitable for use in the compositions of this invention. Included therein are conventionally known acrylates, such as, for example, alkyl esters of acrylic acid, represented by the formula CH₂═CHCOOR, and methacrylic acid, represented by the formula CH₂═CCH₃COOR, where R is a hydrocarbyl or a substituted hydrocarbyl group containing from 1 to 16 carbon atoms. The term “(meth)acrylic acid monomers” is meant to include acrylic acid, methacrylic acid and substituted derivatives thereof.

With reference the emulsion polymer latex of the major component of the present invention, as used herein the term “(meth)acrylate monomers” as used herein is meant also to include the monovinyl acrylate and methacrylate monomers. The (meth)acrylates can include esters, amides and substituted derivatives thereof. Generally, the preferred (meth)acrylates are C₁-C₈ alkyl acrylates and methacrylates.

Examples of suitable (meth)acrylates include methyl acrylate, ethyl acrylate, butyl acrylate, hexyl acrylate, 2-ethylhexyl acrylate, octyl acrylate and isooctyl acrylate, n-decyl acrylate, isodecyl acrylate, tert-butyl acrylate, methyl methacrylate, butyl methacrylate, hexyl methacrylate, isobutyl methacrylate, isopropyl methacrylate as well as 2-hydroxyethyl acrylate and acrylamide. The preferred (meth)acrylates are methyl acrylate, ethyl acrylate, butyl acrylate, 2-ethylhexyl acrylate, octyl acrylate, isooctyl acrylate, methyl methacrylate and butyl methacrylate. Other suitable monomers include lower alkyl acrylates and methacrylates including acrylic and methacrylic ester monomers: methyl acrylate, ethyl acrylate, n-butyl acrylate, t-butyl acrylate, 2-ethylhexyl acrylate, decyl acrylate, isobornyl acrylate, methyl methacrylate, ethyl methacrylate, n-propyl methacrylate, isopropyl methacrylate, n-butyl methacrylate, isobutyl methacrylate, sec-butyl methacrylate, cyclohexyl methacrylate, isodecyl methacrylate, isobornyl methacrylate, t-butylaminoethyl methacrylate, stearyl methacrylate, glycidyl methacrylate, dicyclopentenyl methacrylate, phenyl methacrylate.

In one embodiment, the major component comprises one or more branched vinyl esters as comonomers incorporated into (meth)acrylate polymers. Such (meth)acrylate polymers are commercially available fro The Dow Chemical Company under the tradename NEOCAR 820.

Monomers suitable for use as components in polymers are often classified as “hard” or “soft” monomers, depending upon the glass transition temperature (Tg) of the homopolymer prepared from the monomer. As used herein, a hard monomer is characterized as having a Tg greater than 40° C. for its homopolymer, while a soft monomer is characterized as having a Tg of 40° C. or less for its homopolymer. A preferred hard (meth)acrylate monomer is methyl methacrylate.

The soft non-functional (meth)acrylate monomers have the formula:

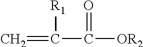

wherein R₁ is selected from the group consisting of hydrogen and methyl, and R₂ is an alkyl group, preferably having up to about 15 carbon atoms. As used herein, the term “alkyl” means cyclic and acyclic saturated hydrocarbon groups that can be either branched or unbranched. Exemplary soft, non-functional acrylic monomers include, but are not limited to, butyl acrylate, isobutyl acrylate, ethylhexyl acrylate, isodecyl methacrylate, lauryl methacrylate, tridecylmethacrylate. Butyl acrylate is a preferred soft, non-functional monomer.

Suitable non-ester monomers that are sometimes classified with the (meth)acrylates are the nitriles. A preferred nitrile monomer is acrylonitrile.

While the more highly preferred embodiment of the (meth)acrylate copolymer of the instant invention may contain up to about 5 weight percent of other comonomers that are not (meth)acrylate monomers, other embodiments may contain as other comonomers as much as 10 weight percent or even as much as 20 weight percent of monomers that are not (meth)acrylate monomers. Other monomers that are useful in these copolymers of the instant invention include vinyl aromatic monomers, aliphatic conjugated diene monomers, monoethylenically unsaturated carboxylic acid monomers, vinyl acetate monomer, vinylidene halide monomer and vinyl halide monomer. In some other desirable copolymers suitable for use in this invention, the monomers of the polymerization mixture include from 1 to 40 weight percent of one or more (meth)acrylate monomers.

As used in the specification and claims, “vinyl aromatic monomers” are defined as any organic compound containing at least one aromatic ring and at least one aliphatic-containing moiety having vinyl unsaturation. Illustrative vinyl aromatic monomers include, but are not limited to, styrene, p-methyl styrene, methyl styrene, o,p-dimethyl styrene, o,p-diethyl styrene, p-chlorostyrene, isopropyl styrene, t-butyl styrene, o-methyl-p-isopropyl styrene, o,p-dichlorostyrene, and mixtures thereof. The preferred vinyl aromatic monomers are styrene and vinyltoluene; and due to its commercial availability and low cost, styrene is the more preferred vinyl aromatic monomer.

The term “conjugated diene monomer,” as used herein, is meant to include compounds such as 1,3-butadiene, isoprene, 1,3-pentadiene, 2-ethyl-1,3-butadiene, and 4-methyl-1,3-pentadiene, 2-methyl-1,3-butadiene, piperylene (1,3-pentadiene), and other hydrocarbon analogs of 1,3-butadiene. The preferred alkadiene monomer is 1,3-butadiene. Other monomers inclusive as aliphatic conjugated dienes are halogenated compounds, such as, for example, 2-chloro-1,3-butadiene.

The monomers of the vinyl group, such as, for example, “vinylidene halides” and “vinyl halides”, are suitable for inclusion in the copolymer of this invention, and include, for example, vinylidene chloride and vinyl chloride, which are highly preferred. Vinylidene bromides and vinyl bromide can also be employed. Another vinyl monomer within the vinyl group is vinyl acetate.

Suitable alpha, beta-ethylenically unsaturated aliphatic carboxylic acid monomers are monoethylenically unsaturated monocarboxylic, dicarboxylic and tricarboxylic acids having the ethylenic unsaturation alpha-beta to at least one of the carboxyl groups and similar monomers having a higher number of carboxyl groups. It is understood that the carboxyl groups may be present in the acid or salt form (—COOM in which M represents a cation such as ammonium, hydrogen or a metal such as, for example, sodium or potassium) and are readily interconvertible by well known simple procedures.

Specific examples of the alpha, beta-ethylenically unsaturated aliphatic carboxylic acids are acrylic acid, methacrylic acid, fumaric acid, itaconic acid, maleic acid, aconitic acid, various alpha-substituted acrylic acids such as alpha-ethacrylic acid, alpha-propyl acrylic acid and alpha-butyl acrylic acid. Highly preferred acid monomers are acrylic acid and methacrylic acid.

With regard to the amount of acid monomer that is desirable or preferred in the copolymer as discussed above, it appears that there is a trade-off in terms of the acid strength of the monomer as indicated by pKa in aqueous solution and the amount of the acid monomer desirably included in the copolymer. While a higher acid content can be tolerated and may be desirable for relatively weak acid monomers, for those acid monomers that are relatively stronger acid monomers, the acid content of the copolymer is desirably less.

In preferred embodiments, the content of alpha, beta-ethylenically unsaturated aliphatic carboxylic acid monomers in the copolymer is desirably in the range from 0 to 4 weight percent, more preferably from 0.2 to 3 weight percent, still more preferably from 0.3 to 2 weight percent.

Within the scope of this invention are other embodiments wherein the copolymer utilized would not be classified as a (meth)acrylate copolymer. Other copolymer types that can be utilized include, for example, combinations of vinyl aromatic monomers with (meth)acrylate monomers, such as, for example, the styrene acrylates, and of vinyl aromatic monomers with conjugated diene monomers, such as, for example, styrene butadiene copolymers, and vinyl ester compounds with (meth)acrylate monomers, such as, for example, (meth)acrylate branched vinyl ester and vinyl acetate branched vinyl ester copolymers. These copolymers may be non-carboxylated or carboxylated.

The copolymer desirably is made, for example, by charging the monomeric ingredients, water, and a surfactant (when employed) into a reaction vessel, purging the reaction vessel with an inert gas, such as, for example, nitrogen, to remove essentially all the oxygen from the reactor vessel, and heating the reactor vessel to the reaction temperature, usually from 80° to 100° C. When the reactor vessel reaches the desired reaction temperature, an initiator and remaining monomeric ingredients are then added to the reaction vessel over time, and the reaction is continued for 2 to 4 hours. After the reaction is completed, the reactor vessel is cooled. This synthesis yields an aqueous copolymeric composition comprising the copolymer in water. In some instances, the composition has the appearance of a milky liquid, while in other instances it looks like a clear solution.

The process of production of the copolymer may include the use of a seed, which may be a (meth)acrylate, polystyrene or any other seed useful to control the ultimate particle size of the copolymer produced, or otherwise useful in the production thereof. As is well known in the art, the regulation of initial seed can be used to control the ultimate range of particle sizes of the copolymer produced. Useful copolymer particle sizes are in the range of from 700 to 10,000 angstroms.

Anionic, nonionic, and amphoteric surface active compounds, that is, surfactants, can be employed in the copolymer synthesis process. However, in some instances, no surfactant is required. Exemplary anionic, nonionic, and amphoteric surfactants are SIPONATE A246L brand surfactant available from Rhone-Poulenc, polyoxyethylene alkyl phenol surfactants, and N,N-bis-carboxyethyl lauramine, respectively. Another useful surfactant is DOWFAX 2EP, the sodium salt of dodecylated sulfonated phenyl ether, which is available from The Dow Chemical Company, Midland, Mich. 48640, U.S.A.

Epoxy

The major component may comprise an epoxy dispersion. Epoxy resin refers to a composition which possesses one or more vicinal epoxy groups per molecule, that is, at least one 1,2-epoxy group per molecule. In general, such compound is a saturated or unsaturated aliphatic, cycloaliphatic, aromatic or heterocyclic compound which possesses at least one 1,2-epoxy group. Such compound can be substituted, if desired, with one or more non-interfering substituents, such as halogen atoms, hydroxy groups, ether radicals, lower alkyls and the like.

Illustrative epoxies are described in the Handbook of Epoxy Resins by H. E. Lee and K. Neville published in 1967 by McGraw-Hill, New York and U.S. Pat. No. 4,066,628, incorporated herein by reference.

Particularly useful compounds which can be used in the practice of the present invention are epoxy resins having the following formula:

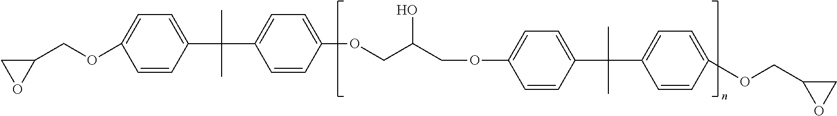

wherein n has an average value of 0 or more.

The epoxy resins useful in the present invention may include, for example, the glycidyl polyethers of polyhydric phenols and polyhydric alcohols. As an illustration, examples of known epoxy resins that may be used in the present invention, include for example, the diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A and any combination thereof.

Examples of diepoxides particularly useful in the present invention include diglycidyl ether of 2,2-bis(4-hydroxyphenyl) propane (generally referred to as bisphenol A) and diglycidyl ether of 2,2-bis(3,5-dibromo-4-hydroxyphenyl) propane (generally referred to as tetrabromobisphenol A). Mixtures of any two or more polyepoxides can also be used in the practice of the present invention.

Other diepoxides which can be employed in the practice of the present invention include the diglycidyl ethers of dihydric phenols, such as those described in U.S. Pat. Nos. 5,246,751; 5,115,075; 5,089,588; 4,480,082 and 4,438,254, all of which are incorporated herein by reference, or the diglycidyl esters of dicarboxylic acids such as those described in U.S. Pat. No. 5,171,820. Other suitable diepoxides include for example, αω-diglycidyloxyisopropylidene-bisphenol-based epoxy resins (commercially known as D.E.R.® 300 and 600 series epoxy resins, products of The Dow Chemical Company, Midland, Mich.).

The epoxy resins which can be employed in the practice of the present invention also include epoxy resins prepared either by reaction of diglycidyl ethers of dihydric phenols with dihydric phenols or by reaction of dihydric phenols with epichlorohydrin (also known as “taffy resins”).

Exemplary epoxy resins include, for example, the diglycidyl ethers of bisphenol A; 4,4′-sulfonyldiphenol; 4,4-oxydiphenol; 4,4′-dihydroxybenzophenone; resorcinol; hydroquinone; 9,9′-bis(4-hydroxyphenyl)fluorene; 4,4′-dihydroxybiphenyl or 4, 4′-dihydroxy-α-methylstilbene and the diglycidyl esters of the dicarboxylic acids.

Other useful epoxide compounds which can be used in the practice of the present invention are cycloaliphatic epoxides. A cycloaliphatic epoxide consists of a saturated carbon ring having an epoxy oxygen bonded to two vicinal atoms in the carbon ring for example as illustrated by the following general formula:

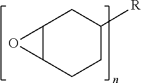

wherein R is a hydrocarbon group optionally comprising one or more heteroatoms (such as, without limitation thereto Cl, Br, and S), or an atom or group of atoms forming a stable bond with carbon (such as, without limitation thereto, Si, P and B) and wherein n is greater than or equal to 1.

The cycloaliphatic epoxide may be a monoepoxide, a diepoxide, a polyepoxide, or a mixture of those. For example, any of the cycloaliphatic epoxide described in U.S. Pat. No. 3,686,359, incorporated herein by reference, may be used in the present invention. As an illustration, the cycloaliphatic epoxides that may be used in the present invention include, for example, (3,4-epoxycyclohexyl-methyl)-3,4-epoxy-cyclohexane carboxylate, bis-(3,4-epoxycyclohexyl) adipate, vinylcyclohexene monoxide and mixtures thereof.

### Polyolefin Dispersions

The major component may comprise a polyolefin dispersion. The polyolefin dispersion may comprise at least one or more base polymers, optionally one or more surfactants, and a fluid medium.

### Base Polymer

The polyolefin dispersion component of the major component comprises from 5 to 99 percent by weight of one or more base polymers, based on the total weight of the solid content of the polyolefin dispersion. All individual values and subranges from 5 to 99 weight percent are included herein and disclosed herein; for example, the weight percent can be from a lower limit of 5, 8, 10, 15, 20, 25 weight percent to an upper limit of 40, 50, 60,70, 80, 90, 95, or 99 weight percent. For example, the polyolefin dispersion may comprise from 15 to 99, or in the alternative from 15 to 90, or in the alternative from 15 to 80 percent by weight of one or more base polymers, based on the total weight of the solid content of the polyolefin dispersion. The polyolefin dispersion dispersion comprises at least one or more base polymers. The base polymer may, for example, be selected from the group consisting of a thermoplastic material, and a thermoset material. The one or more base polymers may comprise one or more olefin based polymers, one or more acrylic based polymers, one or more polyester based polymers, one or more solid epoxy polymers, one or more thermoplastic polyurethane polymers, one or more styrenic based polymers, or combinations thereof.

Examples of thermoplastic materials include, but are not limited to, homopolymers and copolymers (including elastomers) of an alpha-olefins such as ethylene, propylene, 1-butene, 3-methyl-1-butene, 4-methyl-1-pentene, 3-methyl-1-pentene, 1-heptene, 1-hexene, 1-octene, 1-decene, and 1-dodecene, as typically represented by polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers (including elastomers) of an alpha-olefin with a conjugated or non-conjugated diene, as typically represented by ethylene-butadiene copolymer and ethylene-ethylidene norbornene copolymer; and polyolefins (including elastomers) such as copolymers of two or more alpha-olefins with a conjugated or non-conjugated diene, as typically represented by ethylene-propylene-butadiene copolymer, ethylene-propylene-dicyclopentadiene copolymer, ethylene-propylene-1,5-hexadiene copolymer, and ethylene-propylene-ethylidene norbornene copolymer; ethylene-vinyl compound copolymers such as ethylene-vinyl acetate copolymer, ethylene-vinyl alcohol copolymer, ethylene-vinyl chloride copolymer, ethylene acrylic acid or ethylene-(meth)acrylic acid copolymers, and ethylene-(meth)acrylate copolymer; styrenic copolymers (including elastomers) such as polystyrene, ABS, acrylonitrile-styrene copolymer, α-methylstyrene-styrene copolymer, styrene vinyl alcohol, styrene acrylates such as styrene methylacrylate, styrene butyl acrylate, styrene butyl methacrylate, and styrene butadienes and crosslinked styrene polymers; and styrene block copolymers (including elastomers) such as styrene-butadiene copolymer and hydrate thereof, and styrene-isoprene-styrene triblock copolymer; polyvinyl compounds such as polyvinyl chloride, polyvinylidene chloride, vinyl chloride-vinylidene chloride copolymer, polymethyl acrylate, and polymethyl methacrylate; polyamides such as nylon 6, nylon 6,6, and nylon 12; thermoplastic polyesters such as polyethylene terephthalate and polybutylene terephthalate; polycarbonate, polyphenylene oxide, and the like; and glassy hydrocarbon-based resins, including poly-dicyclopentadiene polymers and related polymers (copolymers, terpolymers); saturated mono-olefins such as vinyl acetate, vinyl propionate, vinyl versatate, and vinyl butyrate and the like; vinyl esters such as esters of monocarboxylic acids, including methyl acrylate, ethyl acrylate, n-butyl acrylate, isobutyl acrylate, 2-ethylhexyl acrylate, dodecyl acrylate, n-octyl acrylate, phenyl acrylate, methyl methacrylate, ethyl methacrylate, and butyl methacrylate and the like; acrylonitrile, methacrylonitrile, acrylamide, mixtures thereof; resins produced by ring opening metathesis and cross metathesis polymerization and the like. These resins may be used either alone or in combinations of two or more.

Examples of suitable (meth)acrylates, as base polymers, include methyl acrylate, ethyl acrylate, butyl acrylate, hexyl acrylate, 2-ethylhexyl acrylate, octyl acrylate and isooctyl acrylate, n-decyl acrylate, isodecyl acrylate, tert-butyl acrylate, methyl methacrylate, butyl methacrylate, hexyl methacrylate, isobutyl methacrylate, isopropyl methacrylate as well as 2-hydroxyethyl acrylate and acrylamide. The preferred (meth)acrylates are methyl acrylate, ethyl acrylate, butyl acrylate, 2-ethylhexyl acrylate, octyl acrylate, isooctyl acrylate, methyl methacrylate and butyl methacrylate. Other suitable (meth)acrylates that can be polymerized from monomers include lower alkyl acrylates and methacrylates including acrylic and methacrylic ester monomers: methyl acrylate, ethyl acrylate, n-butyl acrylate, t-butyl acrylate, 2-ethylhexyl acrylate, decyl acrylate, isobornyl acrylate, methyl methacrylate, ethyl methacrylate, n-propyl methacrylate, isopropyl methacrylate, n-butyl methacrylate, isobutyl methacrylate, sec-butyl methacrylate, cyclohexyl methacrylate, isodecyl methacrylate, isobornyl methacrylate, t-butylaminoethyl methacrylate, stearyl methacrylate, glycidyl methacrylate, dicyclopentenyl methacrylate, phenyl methacrylate.

In selected embodiments, base polymer may, for example, comprise a polyolefin selected from the group consisting of ethylene-alpha olefin copolymers, and propylene-alpha olefin copolymers. In particular, in select embodiments, the base polymer may comprise one or more non-polar polyolefins.

In specific embodiments, polyolefins such as polypropylene, polyethylene, copolymers thereof, and blends thereof, as well as ethylene-propylene-diene terpolymers, may be used. In some embodiments, preferred olefinic polymers include homogeneous polymers, as described in U.S. Pat. No. 3,645,992 issued to Elston; high density polyethylene (HDPE), as described in U.S. Pat. No. 4,076,698 issued to Anderson; heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers, which can be prepared, for example, by processes disclosed in U.S. Pat. Nos. 5,272,236 and 5,278,272, the disclosures of which are incorporated herein by reference; and high pressure, free radical polymerized ethylene polymers and copolymers such as low density polyethylene (LDPE) or ethylene vinyl acetate polymers (EVA).

In other particular embodiments, the base polymer may, for example, be ethylene vinyl acetate (EVA) based polymers. In other embodiments, the base polymer may, for example, be ethylene-methyl acrylate (EMA) based polymers. In other particular embodiments, the ethylene-alpha olefin copolymer may, for example, be ethylene-butene, ethylene-hexene, or ethylene-octene copolymers or interpolymers. In other particular embodiments, the propylene-alpha olefin copolymer may, for example, be a propylene-ethylene or a propylene-ethylene-butene copolymer or interpolymer.

In certain other embodiments, the base polymer may, for example, be a semi-crystalline polymer and may have a melting point of less than 110° C. In preferred embodiments, the melting point may be from 25 to 100° C. In more preferred embodiments, the melting point may be between 40 and 85° C.

In one particular embodiment, the base polymer is a propylene/alpha-olefin copolymer, which is characterized as having substantially isotactic propylene sequences. “Substantially isotactic propylene sequences” means that the sequences have an isotactic triad (mm) measured by ¹³C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refer to the isotactic sequence in terms of a triad unit in the copolymer molecular chain determined by ¹³C NMR spectra.

The propylene/alpha-olefin copolymer may have a melt flow rate in the range of from 0.1 to 15 g/10 minutes, measured in accordance with ASTM D-1238 (at 230° C./2.16 Kg). All individual values and subranges from 0.1 to 15 g/10 minutes are included herein and disclosed herein; for example, the melt flow rate can be from a lower limit of 0.1 g/10 minutes, 0.2 g/10 minutes, or 0.5 g/10 minutes to an upper limit of 15 g/10 minutes, 10 g/10 minutes, 8 g/10 minutes, or 5 g/10 minutes. For example, the propylene/alpha-olefin copolymer may have a melt flow rate in the range of 0.1 to 10 g/10 minutes; or in the alternative, the propylene/alpha-olefin copolymer may have a melt flow rate in the range of 0.2 to 10 g/10 minutes.

The propylene/alpha-olefin copolymer has a crystallinity in the range of from at least 1 percent by weight (a heat of fusion of at least 2 Joules/gram) to 30 percent by weight (a heat of fusion of less than 50 Joules/gram). All individual values and subranges from 1 percent by weight (a heat of fusion of at least 2 Joules/gram) to 30 percent by weight (a heat of fusion of less than 50 Joules/gram) are included herein and disclosed herein; for example, the crystallinity can be from a lower limit of 1 percent by weight (a heat of fusion of at least 2 Joules/gram), 2.5 percent (a heat of fusion of at least 4 Joules/gram), or 3 percent (a heat of fusion of at least 5 Joules/gram) to an upper limit of 30 percent by weight (a heat of fusion of less than 50 Joules/gram), 24 percent by weight (a heat of fusion of less than 40 Joules/gram), 15 percent by weight (a heat of fusion of less than 24.8 Joules/gram) or 7 percent by weight (a heat of fusion of less than 11 Joules/gram). For example, the propylene/alpha-olefin copolymer may have a crystallinity in the range of from at least 1 percent by weight (a heat of fusion of at least 2 Joules/gram) to 24 percent by weight (a heat of fusion of less than 40 Joules/gram); or in the alternative, the propylene/alpha-olefin copolymer may have a crystallinity in the range of from at least 1 percent by weight (a heat of fusion of at least 2 Joules/gram) to 15 percent by weight (a heat of fusion of less than 24.8 Joules/gram); or in the alternative, the propylene/alpha-olefin copolymer may have a crystallinity in the range of from at least 1 percent by weight (a heat of fusion of at least 2 Joules/gram) to 7 percent by weight (a heat of fusion of less than 11 Joules/gram); or in the alternative, the propylene/alpha-olefin copolymer may have a crystallinity in the range of from at least 1 percent by weight (a heat of fusion of at least 2 Joules/gram) to 5 percent by weight (a heat of fusion of less than 8.3 Joules/gram). The crystallinity is measured via DSC method, as described above. The propylene/alpha-olefin copolymer comprises units derived from propylene and polymeric units derived from one or more alpha-olefin comonomers. Exemplary comonomers utilized to manufacture the propylene/alpha-olefin copolymer are C₂, and C₄ to C₁₀ alpha-olefins; for example, C₂, C₄, C₆ and C₈ alpha-olefins.

The propylene/alpha-olefin copolymer comprises from 1 to 40 percent by weight of one or more alpha-olefin comonomers. All individual values and subranges from 1 to 40 weight percent are included herein and disclosed herein; for example, the comonomer content can be from a lower limit of 1 weight percent, 3 weight percent, 4 weight percent, 5 weight percent, 7 weight percent, or 9 weight percent to an upper limit of 40 weight percent, 35 weight percent, 30 weight percent, 27 weight percent, 20 weight percent, 15 weight percent, 12 weight percent, or 9 weight percent. For example, the propylene/alpha-olefin copolymer comprises from 1 to 35 percent by weight of one or more alpha-olefin comonomers; or in the alternative, the propylene/alpha-olefin copolymer comprises from 1 to 30 percent by weight of one or more alpha-olefin comonomers; or in the alternative, the propylene/alpha-olefin copolymer comprises from 3 to 27 percent by weight of one or more alpha-olefin comonomers; or in the alternative, the propylene/alpha-olefin copolymer comprises from 3 to 20 percent by weight of one or more alpha-olefin comonomers; or in the alternative, the propylene/alpha-olefin copolymer comprises from 3 to 15 percent by weight of one or more alpha-olefin comonomers.

The propylene/alpha-olefin copolymer has a molecular weight distribution (MWD), defined as weight average molecular weight divided by number average molecular weight (M_{w}/Mₙ) of 3.5 or less; in the alternative 3.0 or less; or in another alternative from 1.8 to 3.0.

Such propylene/alpha-olefin copolymers are further described in details in the U.S. Pat. Nos. 6,960,635 and 6,525,157, incorporated herein by reference. Such propylene/alpha-olefin copolymers are commercially available from The Dow Chemical Company, under the tradename VERSIFY™, or from ExxonMobil Chemical Company, under the tradename VISTAMAXX™. In one embodiment, the propylene/alpha-olefin copolymers are further characterized as comprising (A) between 60 and less than 100, preferably between 80 and 99 and more preferably between 85 and 99, weight percent units derived from propylene, and (B) between greater than zero and 40, preferably between 1 and 20, more preferably between 4 and 16 and even more preferably between 4 and 15, weight percent units derived from at least one of ethylene and/or a C₄₋₁₀ α-olefin; and containing an average of at least 0.001, preferably an average of at least 0.005 and more preferably an average of at least 0.01, long chain branches/1000 total carbons. The maximum number of long chain branches in the propylene interpolymer is not critical to the definition of this invention, but typically it does not exceed 3 long chain branches/1000 total carbons. The term long chain branch, as used herein, refers to a chain length of at least one (1) carbon more than a short chain branch, and short chain branch, as used herein, refers to a chain length of two (2) carbons less than the number of carbons in the comonomer. For example, a propylene/1-octene interpolymer has backbones with long chain branches of at least seven (7) carbons in length, but these backbones also have short chain branches of only six (6) carbons in length. Such propylene/alpha-olefin copolymers are further described in details in the U.S. Provisional Patent Application No. 60/988,999 and International Paten Application No. PCT/US08/082599, each of which is incorporated herein by reference.

In certain other embodiments, the base polymer, for example, propylene/alpha-olefin copolymer, may, for example, be a semi-crystalline polymer and may have a melting point of less than 110° C. In preferred embodiments, the melting point may be from 25 to 100° C. In more preferred embodiments, the melting point may be between 40 and 85° C.

In other selected embodiments, olefin block copolymers, for example, ethylene multi-block copolymer, such as those described in the International Publication No. W02005/090427 and U.S. patent application Ser. No. 11/376,835 may be used as the base polymer. Such olefin block copolymer may be an ethylene/α-olefin interpolymer:

(a) having a M_{w}/Mₙ from 1.7 to 3.5, at least one melting point, Tₘ, in degrees Celsius, and a density, d, in grams/cubic centimeter, wherein the numerical values of Tₘ and d corresponding to the relationship:

Tₘ>−2002.9+4538.5(d)−2422.2(d)²; or

(b) having a M_{w}/Mₙ from 1.7 to 3.5, and being characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH having the following relationships:

ΔT>−0.1299(ΔH)+62.81 for ΔH greater than zero and up to 130 J/g,

ΔT≧48° C. for ΔH greater than 130 J/g,

wherein the CRYSTAF peak being determined using at least 5 percent of the cumulative polymer, and if less than 5 percent of the polymer having an identifiable CRYSTAF peak, then the CRYSTAF temperature being 30° C.; or (c) being characterized by an elastic recovery, Re, in percent at 300 percent strain and 1 cycle measured with a compression-molded film of the ethylene/α-olefin interpolymer, and having a density, d, in grams/cubic centimeter, wherein the numerical values of Re and d satisfying the following relationship when ethylene/α-olefin interpolymer being substantially free of a cross-linked phase:

Re>1481−1629(d); or

(d) having a molecular fraction which elutes between 40° C. and 130° C. when fractionated using TREF, characterized in that the fraction having a molar comonomer content of at least 5 percent higher than that of a comparable random ethylene interpolymer fraction eluting between the same temperatures, wherein said comparable random ethylene interpolymer having the same comonomer(s) and having a melt index, density, and molar comonomer content (based on the whole polymer) within 10 percent of that of the ethylene/α-olefin interpolymer; or

(e) having a storage modulus at 25° C., G′ (25° C.), and a storage modulus at 100° C., G′ (100° C.), wherein the ratio of G′ (25° C.) to G′ (100° C.) being in the range of 1:1 to 9:1.

The ethylene/α-olefin interpolymer may also: (a) have a molecular fraction which elutes between 40° C. and 130° C. when fractionated using TREF, characterized in that the fraction having a block index of at least 0.5 and up to about 1 and a molecular weight distribution, M_{w}/Mₙ, greater than about 1.3; or

(b) have an average block index greater than zero and up to about 1.0 and a molecular weight distribution, M_{w}/Mₙ, greater than about 1.3.

In certain embodiments, the base polymer may, for example, comprise a polar polymer, having a polar group as either a comonomer or grafted monomer. In exemplary embodiments, the base polymer may, for example, comprise one or more polar polyolefins, having a polar group as either a comonomer or grafted monomer. Exemplary polar polyolefins include, but are not limited to, ethylene-acrylic acid (EAA) and ethylene-methacrylic acid copolymers, such as those available under the trademarks PRIMACOR™, commercially available from The Dow Chemical Company, NUCREL™, commercially available from E.I. DuPont de Nemours, and ESCOR™, commercially available from ExxonMobil Chemical Company and described in U.S. Pat. Nos. 4,599,392, 4,988,781, and 5,938,437, each of which is incorporated herein by reference in its entirety. Other exemplary base polymers include, but are not limited to, ethylene ethyl acrylate (EEA) copolymer, ethylene methyl methacrylate (EMMA), and ethylene butyl acrylate (EBA).

In one embodiment, the base polymer may, for example, comprise a polar polyolefin selected from the group consisting of ethylene-acrylic acid (EAA) copolymer, ethylene-methacrylic acid copolymer, and combinations thereof, and the stabilizing agent may, for example, comprise a polar polyolefin selected from the group consisting of ethylene-acrylic acid (EAA) copolymer, ethylene-methacrylic acid copolymer, and combinations thereof; provided, however, that base polymer may, for example, have a lower acid number, measured according to D-974, that the stabilizing agent.

In certain embodiments, the base polymer may, for example, comprise a polyester resin. Polyester resin refers to thermoplastic resins that may include polymers containing at least one ester bond. For example, polyester polyols may be prepared via a conventional esterification process using a molar excess of an aliphatic diol or glycol with relation to an alkanedioic acid. Illustrative of the glycols that can be employed to prepare the polyesters are ethylene glycol, diethylene glycol, propylene glycol, dipropylene glycol, 1,3-propanediol, 1,4-butanediol and other butanediols, 1,5-pentanediol and other pentane diols, hexanediols, decanediols, and dodecanediols. In some embodiments, the aliphatic glycol may contain from 2 to 8 carbon atoms. Illustrative of the dioic acids that may be used to prepare the polyesters are maleic acid, malonic acid, succinic acid, glutaric acid, adipic acid, 2-methyl-1,6-hexanoic acid, pimelic acid, suberic acid, and dodecanedioic acids. In some embodiments, the alkanedioic acids may contain from 4 to 12 carbon atoms. Illustrative of the polyester polyols are poly(hexanediol adipate), poly(butylene glycol adipate), poly(ethylene glycol adipate), poly(diethylene glycol adipate), poly(hexanediol oxalate),and poly(ethylene glycol sebecate. Other embodiments of the present invention use polyester resins containing aliphatic diols such as UNOXOL (a mixture of cis and trans 1,3- and 1,4-cyclohexanedimethanol) available from The Dow Chemical Company (Midland, MI).

In certain embodiments, the base polymer may, for example, comprise a thermoset material comprising an epoxy resin, as described hereinabove.

In certain embodiments, the base polymer comprises a thermoplastic polyurethane polymer. Such thermoplastic polyurethane polymers are generally know, and further described, for example, in the International Publication No. 2008/057878, incorporated herein by reference to the extent that it describes a thermoplastic polyurethane polymer.

Those having ordinary skill in the art will recognize that the above list is a non-comprehensive listing of exemplary base polymers. It will be appreciated that the scope of the present invention is restricted by the claims only.

### Stabilizing Agent

The polyolefin dispersion of the major component according to the present invention may further comprise at least one or more stabilizing agents, also referred to herein as dispersion or dispersing agents, to promote the formation of a stable polyolefin dispersion. The stabilizing agent may preferably be an external stabilizing agent. The polyolefin dispersion of the instant invention comprises 1 to 50 percent by weight of one or more stabilizing agents, based on the total weight of the solid content of the dispersion. All individual values and subranges from 1 to 45 weight percent are included herein and disclosed herein; for example, the weight percent can be from a lower limit of 1, 3, 5, 10 weight percent to an upper limit of 15, 25, 35 , 45, or 50 weight percent. For example, the dispersion may comprise from 1 to 25, or in the alternative from 1 to 35, or in the alternative from 1 to 40, or in the alternative from 1 to 45 percent by weight of one or more stabilizing agents, based on the total weight of the solid content of the dispersion. In selected embodiments, the stabilizing agent may be a surfactant, a polymer, or mixtures thereof. In certain embodiments, the stabilizing agent can be a polar polymer, having a polar group as either a comonomer or grafted monomer. In exemplary embodiments, the stabilizing agent comprises one or more polar polyolefins, having a polar group as either a comonomer or grafted monomer. Exemplary polymeric stabilizing agents include, but are not limited to, ethylene-acrylic acid (EAA) and ethylene-methacrylic acid copolymers, such as those available under the trademarks PRIMACOR™, commercially available from The Dow Chemical Company, NUCREL™, commercially available from E.I. DuPont de Nemours, and ESCOR™, commercially available from ExxonMobil Chemical Company and described in U.S. Pat. Nos. 4,599,392, 4,988,781, and 5,938,437, each of which is incorporated herein by reference in its entirety. Other exemplary polymeric stabilizing agents include, but are not limited to, ethylene ethyl acrylate (EEA) copolymer, ethylene methyl methacrylate (EMMA), and ethylene butyl acrylate (EBA). Other ethylene-carboxylic acid copolymer may also be used. Those having ordinary skill in the art will recognize that a number of other useful polymers may also be used.

Other stabilizing agents that may be used include, but are not limited to, long chain fatty acids, fatty acid salts, or fatty acid alkyl esters having from 12 to 60 carbon atoms. In other embodiments, the long chain fatty acid or fatty acid salt may have from 12 to 40 carbon atoms.

The stabilizing agent may be partially or fully neutralized with a neutralizing agent. In certain embodiments, neutralization of the stabilizing agent, such as a long chain fatty acid or EAA, may be from 25 to 200 percent on a molar basis; or in the alternative, it may be from 50 to 110 percent on a molar basis. For example, for EAA, the neutralizing agent may be a base, such as ammonium hydroxide or potassium hydroxide, for example. Other neutralizing agents can include lithium hydroxide or sodium hydroxide, for example. In another alternative, the neutralizing agent may, for example, be a carbonate. In another alternative, the neutralizing agent may, for example, be any amine such as monoethanolamine, or 2-amino-2-methyl-1-propanol (AMP). Amines useful in embodiments disclosed herein may include monoethanolamine, diethanolamine, triethanolamine, and TRIS AMINO (each available from Angus), NEUTROL TE (available from BASF), as well as triisopropanolamine, diisopropanolamine, and N,N-dimethylethanolamine (each available from The Dow Chemical Company, Midland, Mich.). Other useful amines may include ammonia, monomethylamine, dimethylamine, trimethylamine, monoethylamine, diethylamine, triethylamine, mono-n-propylamine, dimethyl-n propylamine, N-methanol amine, N-aminoethylethanolamine, N-methyldiethanolamine, monoisopropanolamine, N,N-dimethyl propanolamine, 2-amino-2-methyl-1-propanol, tris(hydroxymethyl)-aminomethane, N,N,N′N′-tetrakis(2-hydroxylpropyl) ethylenediamine, 1.2-diaminopropane. In some embodiments, mixtures of amines or mixtures of amines and surfactants may be used. Those having ordinary skill in the art will appreciate that the selection of an appropriate neutralizing agent depends on the specific composition formulated, and that such a choice is within the knowledge of those of ordinary skill in the art.

Additional stabilizing agents that may be useful in the practice of the present invention include, but are not limited to, cationic surfactants, anionic surfactants, or non-ionic surfactants. Examples of anionic surfactants include, but are not limited to, sulfonates, carboxylates, and phosphates. Examples of cationic surfactants include, but are not limited to, quaternary amines. Examples of non-ionic surfactants include, but are not limited to, block copolymers containing ethylene oxide and silicone surfactants. Stabilizing agents useful in the practice of the present invention can be either external surfactants or internal surfactants. External surfactants are surfactants that do not become chemically reacted into the base polymer during dispersion preparation. Examples of external surfactants useful herein include, but are not limited to, salts of dodecyl benzene sulfonic acid and lauryl sulfonic acid salt. Internal surfactants are surfactants that do become chemically reacted into the base polymer during dispersion preparation. An example of an internal surfactant useful herein includes 2,2-dimethylol propionic acid and its salts. Additional surfactants that may be useful in the practice of the present invention include cationic surfactants, anionic surfactants, non-ionic surfactants, or combinations thereof. Various commercially available surfactants may be used in embodiments disclosed herein, including: OP-100 (a sodium stearate), OPK-1000 (a potassium stearate), and OPK-181 (a potassium oleate), each available from RTD Hallstar; UNICID 350, available from Baker Petrolite; DISPONIL FES 77-IS and DISPONIL TA-430, each available from Cognis; RHODAPEX CO-436, SOPROPHOR 4D384, 3D-33, and 796/P, RHODACAL BX-78 and LDS-22, RHODAFAC RE-610, and RM-710, and SUPRAGIL MNS/90, each available from Rhodia; and TRITON QS-15, TRITON W-30, DOWFAX 2A1, DOWFAX 3B2, DOWFAX 8390, DOWFAX C6L, TRITON X-200, TRITON XN-455, TRITON H-55, TRITON GR-5M, TRITON BG-10, and TRITON CG-110, each available from The Dow Chemical Company, Midland, Mich.

### Fluid Medium

The polyolefin dispersion further comprises a fluid medium. The fluid medium may be any medium; for example, the fluid medium may be water. The polyolefin dispersion of the instant invention comprises 35 to 80 percent by volume of fluid medium, based on the total volume of the dispersion. In particular embodiments, the water content may be in the range of from 35 to 75, or in the alternative from 35 to 70, or in the alternative from 45 to 60 percent by volume, based on the total volume of the dispersion. Water content of the polyolefin dispersion may preferably be controlled so that the solids content (base polymer plus stabilizing agent) is between 1 percent to 74 percent by volume. In particular embodiments, the solids range may be between 10 percent to 70 percent by volume. In other particular embodiments, the solids range is between 20 percent to 65 percent by volume. In certain other embodiments, the solids range is between 25 percent to 55 percent by volume.

### Additional Components

The polyolefin dispersion according to the present invention may further comprise one or more binder compositions such as acrylic latex, vinyl acrylic latex, styrene acrylic latex, vinyl acetate ethylene latex, and combinations thereof; optionally one or more fillers; optionally one or more additives; optionally one or more pigments, for example, titanium dioxide, mica, calcium carbonate, silica, zinc oxide, milled glass, aluminum trihydrate, talc, antimony trioxide, fly ash, and clay; optionally one or more co-solvents, for example, glycols, glycol ether, 2,2,4-trimethyl-1,3-pentanediol monoisobutyrate, alcohols, mineral spirits, and benzoate esters; optionally one or more dispersants, for example, aminoalcohols, and polycarboxylates; optionally one or more surfactants; optionally one or more defoamers; optionally one or more preservatives, for example, biocides, mildewcides, fungicides, algaecides, and combinations thereof; optionally one or more thickeners, for example, cellulosic based thickeners such as hydroxyethyl cellulose, hydrophobically modified alkali soluble emulsions (HASE thickeners such as UCAR POLYPHOBE TR-116) and hydroobically modified ethoxylated urethane thickeners (HEUR); or optionally one or more additional neutralizing agents, for example, hydroxides, amines, ammonia, and carbonates.

### Additional Colorant Components

The polyolefin dispersion may further comprise a colorant as part of the polyolefin dispersion. A variety of colors may be used. Examples include colors such as yellow, magenta, and cyan. As a black coloring agent, carbon black, and a coloring agent toned to black using the yellow/magenta/cyan coloring agents shown below may be used. Colorants, as used herein, include dyes, pigments, and pre-dispersions, among others. These colorants may be used singly, in a mixture, or as a solid solution. In various embodiments, pigments may be provided in the form of raw pigments, treated pigments, pre-milled pigments, pigment powders, pigment presscakes, pigment masterbatches, recycled pigment, and solid or liquid pigment pre-dispersions. As used herein, a raw pigment is a pigment particle that has had no wet treatments applied to its surface, such as to deposit various coatings on the surface. Raw pigment and treated pigment are further discussed in PCT Publication No. WO 2005/095277 and U.S. Patent Application Publication No. 20060078485, the relevant portions of which are incorporated herein by reference. In contrast, a treated pigment may have undergone wet treatment, such as to provide metal oxide coatings on the particle surfaces. Examples of metal oxide coatings include alumina, silica, and zirconia. Recycled pigment may also be used as the starting pigment particles, where recycled pigment is pigment after wet treatment of insufficient quality to be sold as coated pigment.

Exemplary colorant particles include, but are not limited to, pigments such as yellow coloring agent, compounds typified by a condensed azo compound, an isoindolynone compound, an anthraquinone compound, an azometal complex methine compound, and an allylamide compound as pigments may be used. As a magenta coloring agent, a condensed azo compound, a diketopyrrolopyrrole compound, anthraquinone, a quinacridone compound, a base dye lake compound, a naphthol compound, a benzimidazolone compound, a thioindigo compound, and a perylene compound may be used. As a cyan coloring agent, a copper phthalocyanine compound and its derivative, an anthraquinone compound, a base dye lake compound, and the like may be used.

### Forming the Polyolefin Dispersion

The polyolefin dispersion according to the present invention can be formed by any number of methods recognized by those having skill in the art. In one embodiment, one or more base polymers, one or more stabilizing agents are melt-kneaded in an extruder along with water and a neutralizing agent, such as ammonia, potassium hydroxide, or a combination of the two to form a polyolefin dispersion. In another embodiment, one or more base polymers and optionally one or more fillers are compounded, and then the base polymer/filler compound is melt-kneaded in an extruder in the presence of an optional stabilizing agent, water, and one or more neutralizing agents thereby forming a polyolefin dispersion. In some embodiments, the dispersion is first diluted to contain 1 to 3 percent by weight water and then, subsequently, further diluted to comprise greater than about 25 percent by weight water.

Any melt-kneading means known in the art may be used. In some embodiments, a kneader, a BANBURY® mixer, single-screw extruder, or a multi-screw extruder, for example, a twin screw extruder, is used. A process for producing the dispersions in accordance with the present invention is not particularly limited. For example, an extruder, in certain embodiments, for example, a twin screw extruder, is coupled to a back pressure regulator, melt pump, or gear pump. Exemplary embodiments also provide a base reservoir and an initial water reservoir, each of which includes a pump. Desired amounts of base and initial water are provided from the base reservoir and the initial water reservoir, respectively. Any suitable pump may be used, but in some embodiments, for example, a pump that provides a flow of about 150 cc/min at a pressure of 240 bar is used to provide the base and the initial water to the extruder. In other embodiments, a liquid injection pump provides a flow of 300 cc/min at 200 bar or 600 cc/min at 133 bar. In some embodiments, the base and initial water are preheated in a preheater.

One or more base polymers, in the form of pellets, powder, or flakes, are fed from the feeder to an inlet of the extruder where the resin is melted or compounded. Optionally one or more fillers may be fed simultaneously with one or more base polymers into the extruder via the feeder; or in the alternative, one or more fillers may be compounded into one or more base polymers, and then fed into the extruder via the feeder. In the alternative, additional one or more fillers may further be metered via an inlet prior to the emulsification zone into the molten compound comprising one or more base polymers and optionally one or more fillers. In some embodiments, the dispersing agent is added to one or more base polymers through and along with the resin and in other embodiments, the dispersing agent is provided separately to the twin screw extruder. The resin melt is then delivered from the mix and convey zone to an emulsification zone of the extruder where the initial amount of water and base from the water and base reservoirs are added through an inlet. In some embodiments, dispersing agent may be added additionally or exclusively to the water stream. In some embodiments, further dilution water may be added via water inlet from water reservoir in a dilution and cooling zone of the extruder. Typically, the dispersion is diluted to at least 30 weight percent water in the cooling zone. In addition, the diluted mixture may be diluted any number of times until the desired dilution level is achieved. In some embodiments, water is not added into the twin screw extruder but rather to a stream containing the resin melt after the melt has exited from the extruder. In this manner, steam pressure build-up in the extruder is eliminated and the dispersion is formed in a secondary mixing device such as a rotor stator mixer.

### Forming the Hybrid Dispersion

The process for producing the hybrid dispersion comprises the following steps: (1) selecting a hydrophobic polyurethane dispersion derived from one or more natural oil based polyols or a hydrophobic polyurethane prepolymer derived from one or more natural oil based polyols; (2) selecting a second dispersion selected from the group consisting of latex, epoxy, and polyolefin dispersion; (3) blending the minor component into the major component; (4) and thereby producing said hybrid dispersion.

The minor component and the major component may be admixed to form the hybrid dispersion via a continues process or a batch process. Such admixing may be achieved via, for example, stiffing, Oaks mixer, IKEA mixer, or the like.

### End-Use Applications

The hybrid dispersions of the present invention may be used, for example, in different coating applications such as industrial coating applications, architectural coating applications, automotive coating applications, outdoor furniture coating applications.

The coated articles or structures according to the present invention comprise a coating layer associated with one or more surfaces of an article or a structure, wherein said coating layer is derived from the inventive hybrid dispersion according to the present invention.

The hybrid dispersions according to the present invention are film forming compositions. The films derived from the inventive hybrid dispersions may have any thickness; for example, such films may have a thickness in the range of from 0.01 μm to 1 mm; or in the alternative, from 1 μm to 500 μm; or in the alternative, from 1 μm to 100 μm; or in the alternative, from 1 to 50 μm; or in the alternative, from 1 μm to 25 μm; or in the alternative, from 1 to 10 μm.

The method for coating articles or structures according to the present invention comprises the steps of (1) selecting the inventive hybrid dispersion (2) applying the hybrid dispersion to one or more surfaces of an article or a structure; (3) removing a portion of water from the hybrid dispersion associated with one or more surfaces of the article or structure; and (4) thereby coating the article or structure.

The hybrid dispersion may be applied to one or more surfaces of an article or a structure via any method. Such method include, but are not limited to, spraying, dipping, rolling, and any other conventional technique generally known to those skilled in the art. The inventive hybrid dispersion may be applied to one or more surfaces of an article or structure at a temperature in the range of greater than about 5° C. Such structures include, but are not limited to, commercial building, residential buildings, and warehouses. The inventive hybrid dispersions may be used as coatings for interior applications, exterior applications, or combinations thereof. The surface of such structures to be coated with the inventive hybrid dispersion may comprise concrete, wood, metal, plastic, glass, drywall, or the like.

### EXAMPLES

The following examples illustrate the present invention but are not intended to limit the scope of the invention. The examples of the instant invention demonstrate that coated articles or structures in accordance with the present invention possess improved properties such as dirt-pickup-resistance properties, stain and block resistance properties, and low water pick-up properties.

### Preparation of Prepolymer

The prepolymer formulation utilized a UNOXOL™ Diol initiated methylhydroxy methyl stearate (HMS) polyol having an equivalent weight (EW) of 464. 26.7 grams of dimethylolpropionic acid (DMPA), 108.9 grams of N-methyl-2-pyrrolidone (NMP), 206.0 grams of HMS polyol, and 0.215 grams of dibutyltin dilaurate catalyst were added to a one liter five-neck glass round bottom flask equipped with a mechanical stirrer, condenser, addition funnel, nitrogen inlet, and a thermocouple to monitor reaction temperature. The mixture was heated to 80° C. with stirring using an external hot oil bath. The temperature was maitained at 80° C. (±2° C.) with nitrogen flowing through the system for two hours to remove any moisture from the system. The mixture was then cooled to approximately 70° C., and water was turned on to cool the condenser. 158.9 grams of isophorone diisocyanate (IPDI) was slowly added to the reaction mixture using the addition funnel while maintaining the temperature at approximately 70° C. (±2° C.) during the addition. Once all of the IPDI was added, the reaction temperature was increased to and maintained at approximately 82° C., for three hours. The reaction mixture was then cooled to 67° C. and 17.1 grams of triethylamine (TEA) was added while maintaining the temperature at 67° C. for an additional 30 minutes.

### Preparation of the Hydrophobic Polyurethane Dispersion (PUD)

510 grams of the above described prepolymer at 67° C. was poured from the round bottom flask into a one liter plastic jar. The plastic jar containing prepolymer was placed on a high speed mixer, and 404 grams of water was added to disperse the prepolymer. A mixture of 15.8 grams of ethylenediamine (EDA) in 152 grams water was then slowly added one drop at a time to the dispersion for the chain extension step. The final dispersion was stored at room temperature.

### Preparation of the Latex Based Pigmented Paint A

A pigment grind is prepared by mixing the following ingredients using a Cowles disperser.

Pigment Grind

| Ingredients | grams |
|---|---|
| Water | 143.0 |
| CELLOSIZE ® Hydroxyethyl Cellulose ER-52,000 | 4.0 |
| Colloid 226/35 (available from Rhône-Poulenc) | 8.0 |
| Potassium Tripolyphosphate (KTPP) | 2.0 |
| Ethylene Glycol | 20.0 |
| Surfynol 104 (available from Air Products) | 1.2 |
| Colloid 643(available from Rhône-Poulenc) | 1.5 |
| Ti-Pure” R-960 (available from Du Pont) | 103.0 |
| Atomite(ExxonMobil Chemical Company) | 385.0 |
| Eagle 417w | 40.6 |
| Polyphase P20T | 5.0 |
| Total: | 713.3 |

Subsequently, the following ingredients are introduced and mixed:

| | |
|---|---|
| UCAR ® DE 156 latex | 496.6 |
| UCAR ® filmer IBT | 6.0 |
| Colloid 643 (available from Rhône-Poulenc) | 2.0 |
| Ammonium Hydroxide (28%) Aqueous Solution | 2.5 |
| Total: | 507.1 |

The resulting paint has following characteristics:

Pigment Volume Concentration (PVC %): 40.0

Total Solids Percent:
by Volume: 53.8
by Weight: 68.5

Stormer viscosity KU: 110

Preparation of Blends of PUD with Latex:

Hybrid blends were prepared. The PUD, as described above, having a solid content of 34 weight percent and the latex based pigmented paint A (Base A) were prepared admixed via stirring to form hybrid dispersions, based on the formulations reported in Table 1. The inventive samples 1-3 and comparative Base A (without PUD) were tested for their properties, and the results are reported in Table 2.

TABLE 1

| Samples | Inventive 1 | Inventive 2 | Inventive 3 |
|---|---|---|---|
| Amount of PUD (g) | 240 | 200 | 160 |
| Amount Base A (g) | 25.4 | 57.6 | 107.5 |
| Total (g) | 265.4 | 257.6 | 267.5 |
| % solids | 65.2 | 60.8 | 54.6 |
| Composition | 5% PUD | 12.5% PUD | 25% PUD |
| (dry/dry) | 95% latex | 87.5% latex | 75% latex |

TABLE 2

| | | Mechanical | | | | |
|---|---|---|---|---|---|---|
| | % PUD | Properties | | | | DPR |
| | in blend | | Elonga- | Water Uptake | | % drop in |
| Sample | (dry/dry) | Tensile | tion | % swelling | | reflectance |
| Comparative | 0 | 330 | 230 | 30 | 30 | 45 |
| 1 (Base A) | | | | | | |
| Inventive 1 | 5 | 435 | 170 | 10 | 9.5 | 35 |
| Inventive 2 | 12.5 | 655 | 100 | 10 | 5.8 | 25 |
| Inventive 3 | 25 | 820 | 90 | 10 | 8.6 | 31 |

The inventive samples 1-3 passed the low temperature flexibility test (Mandrel Bend) after 1000 hours in the wheatherometer. The above results clearly indicate that the water uptake is dramatically decreased with as little as 5 percent PUD in the hybrid blend. The drop in reflectance has also been reduced from 45 percent down to around 30 percent when PUD is present in the blend.

### Water Absorption (Moisture Resistance)

Water absorption was determined according to the following procedure:
1—Fill a 30-50 mil Teflon® mold with a coating sample.
2—Strike down to obtain a smooth surface.
3—Allow to remain for 7 days at 25 C and 50 percent relative humidity.
4—Flip the sample over and place back in the mold. The side previously face down in the mold, should now be face up.
5—Leave for an additional 7 days at 25 C and 50 percent relative humidity.
6—Using a template cut two strips that are approximately 1.75 inches long and 0.75 inches wide.
7—Take an initial weight of the cut strip and measure the thickness.
8—Obtain two polyethylene cups with lids.
9—Place one test strip into each of the cups.
10—Add water until samples are completely submerged.
11—Cover the cup with lid.
12—After 1, 3, and 7 days, remove the strip's from the container, blot dry, and record a weight.
13—Take a sample thickness reading at 7 days.

### Low Temperature Flexibility (Mandrel Bend)

Low temperature flexibility was measured according to the following procedure:
1—Clean anodized Aluminum substrate using a 50 percent isopropyl alcohol and rinse with deionized water.
2—Apply a 10 mil drawdown of material to the substrate.
3—Allow the film to dry for 14 days.
4—Place into a QUV chamber for 500 hours of cycles of 8 hours ultraviolet light

(UVA-340 bulbs) at 60 C followed by 4 hours of condensing humidity in the dark.
5—Remove and place into a −15′ F freezer for 4 hours.
6—Bend using a ⅛ inch mandrel.
7—Note any cracking or adhesion loss.

### Coating's Dirt Pick-Up Resistance Testing Method (China National Standard)

This method uses coal ash as dirt medium, mixes it with water and pastes it onto the painted sample panel. Dry it and flush with water, after defined cycles, measure the drop of reflectance value of the painted panel. This represents the coating's Dirt Pick-up Resistance property.

### Materials and Apparatus.

Coal ash.
Reflectometer.
Balance.
Soft hair brush (width: 25-50 mm)
Water flushing apparatus.

### Testing Procedure

1. Preparation of Coal Ash Water.

Weigh out suitable amount of coal ash and mix with water at 1:1 ratio.

2. Testing Steps.

Measure 3 points of reflectance value from the fully dried white painted panels. Take the average, and mark it as “A”.

Use the soft hair brush to brush (0.7±0.1 gm) coal ash water onto the paint panel cross-over evenly. Dry it for 2 hrs at 23±2° C./RH 50±5 percent condition. Then put the panel onto the sample rack of the water flushing apparatus. Add in 15 liter of water into the water holding tank of the water flushing apparatus. Fully turn on the tap of the water tank and allow the running water to flush the panel for 1 minute. Then turn off the tap. If necessary, move the panel slightly, so that every position of the panel can be evenly rinsed with the running water. Dry the panel at 23±2° C./RH 50±5 percent for 24 hrs, This is call one cycle.

Repeat for 5 cycles. Each cycle, the water tank must be filled up with 15 liters of water. Measure 3 points of reflectance value from the dried panel, take the average value, and mark down as “B”.

3. Calculation

Calculations are based on the followings:
X=Drop of reflectance value
A=Initial reflectance value
B=Final reflectance value after 5 cycles.
The drop of reflectance value:

$$X = \frac{A - B}{A} \times 100$$

Remark: Take the average of 3 panels; the deviation should not be greater than 10 percent.

### Preparation of Additional Hybrid Dispersions of PUD and DL 633 Latex

The following samples inventive 4-8 and comparative B were prepared by mixing the ingredients, shown in Table 3, using a cowles blade stirrer. Paint drawdowns were made on Leneta black plastic charts and allowed to dry for seven days in a 50 percent humidity chamber at 25° C.

TABLE 3

| | | Comparative | Inventive | Inventive | Inventive | Inventive | Inventive |
|---|---|---|---|---|---|---|---|
| % solids | Ingredient | B | 4 | 5 | 6 | 7 | 8 |
| 50.0% | Amount DL | 50.0 | 50.0 | 50.0 | 50.0 | 50.0 | 50.0 |
| | 633 (g) | | | | | | |
| 34.0% | Amount PUD | 0.0 | 1.9 | 3.9 | 8.2 | 13.0 | 24.5 |
| | seed oil (g) | | | | | | |
| | % PUD in | 0.0 | 2.5 | 5.0 | 10.0 | 15.0 | 25.0 |
| | blend (dry/dry) | | | | | | |
| 76.5% | Amount TiO2 | 30.5 | 30.5 | 30.5 | 30.5 | 30.5 | 30.5 |
| | slurry L746 | | | | | | |
| 100% | Texanol | 3.7 | 3.7 | 3.7 | 3.7 | 3.7 | 3.7 |
| 100% | Water | 18.3 | 16.4 | 14.5 | 10.2 | 5.3 | 0.1 |
| 100% | Antifoam | 0.40 | 0.40 | 0.40 | 0.40 | 0.40 | 0.40 |
| | L-475 | | | | | | |
| | Total | 102.9 | 102.9 | 102.9 | 102.9 | 102.9 | 109.2 |
| | Amount (g) | | | | | | |

All coatings were subsequently evaluated for washability, stain and blocking resistance according to the methods described hereinbelow, and the results are reported in Table 4.

TABLE 4

| | | Comparative | Inventive | Inventive | Inventive | Inventive | Inventive |
|---|---|---|---|---|---|---|---|
| | Samples | B | 4 | 5 | 6 | 7 | 8 |
| | % PUD in | 0% | 2.5% | 5.0% | 10.0% | 15.0% | 25.0% |
| | blend (dry/dry) | | | | | | |
| Washability | Stains - % Removed ± 10% | | | | | | |
| 200 cycles | crayon | 100 | 100 | 100 | 100 | 100 | 98 |
| w/409 cleaner | | | | | | | |
| | mustard | 50 | 50 | 50 | 50 | 50 | 50 |
| | ketchup | 90 | 98 | 100 | 100 | 100 | 100 |
| | grape juice | 95 | 95 | 100 | 100 | 100 | 100 |
| | pen | 20 | 20 | 40 | 30 | 30 | 20 |
| | marker | 60 | 70 | 70 | 90 | 100 | 90 |
| Block | Rating | | | | | | |
| Resistance | | | | | | | |
| | 1 day Room T | 4 | 4 | 4 | 5 | 6 | 6 |
| | 1 day at 120° F. | 2 | 4 | 2 | 4 | 5 | 5 |
| | 7 days Room T | 5 | 6 | 5 | 6 | 7 | 7 |
| | 7 days at 120° F. | 4 | 5 | 4 | 5 | 6 | 6 |
| K&N Staining | Initial y - vlaue | 94.2 | 92.4 | 93.0 | 93.5 | 93.7 | 93.0 |
| | Final y - value | 92.9 | 90.7 | 91.7 | 92.1 | 92.7 | 91.6 |
| | % Remaining | 1.4 | 1.8 | 1.4 | 1.5 | 1.0 | 1.5 |
| Nigrosine | Initial y - vlaue | 94.01 | 92.28 | 93.07 | 93.36 | 93.32 | 92.65 |
| Staining | | | | | | | |
| Sealed | Final y - value | 93.26 | 91.70 | 92.71 | 93.16 | 93.06 | 92.57 |
| | % Remaining | 0.80 | 0.63 | 0.39 | 0.21 | 0.28 | 0.09 |
| Nigrosine | Initial y - vlaue | 93.98 | 92.29 | 93.47 | 93.77 | 93.54 | 92.33 |
| Staining | | | | | | | |
| Unsealed | Final y - value | 92.70 | 91.25 | 92.85 | 93.40 | 93.03 | 91.97 |
| | % Remaining | 1.36 | 1.13 | 0.66 | 0.39 | 0.55 | 0.39 |

The above results, shown in Table 4, indicate that block resistance at 15 percent PUD level is significantly improved both at room temperature and 120° F. The above results, shown in Table 4, indicate that in nigrosine staining, in both sealed and unsealed paper coatings, and above 5 percent PUD in the composition, the staining is significantly reduced.

### Preparation of Additional Hybrid Dispersions of PUD and NEOCAR™ 820 Latex

As explained above, the following inventive sample 9-13 and comparative sample C, were prepared, according to the ingredients shown in Table 5. The samples were tested for ther properties, and the results are shown in Table 6.

TABLE 5

| | | Comparative | Inventive | Inventive | Inventive | Inventive | Inventive |
|---|---|---|---|---|---|---|---|
| % solids | Ingredient | C | 9 | 10 | 11 | 12 | 13 |
| 45.0% | Amount | 60.0 | 60.0 | 60.0 | 60.0 | 60.0 | 55.0 |
| | Neocar ™ | | | | | | |
| | 820 latex (g) | | | | | | |
| 34.0% | Amount | 0.0 | 2.0 | 4.2 | 8.8 | 14.0 | 24.3 |
| | PUD seed | | | | | | |
| | oil (g) | | | | | | |
| | % PUD in | 0.0 | 2.5 | 5.0 | 10.0 | 15.0 | 25.0 |
| | blend | | | | | | |
| | (dry/dry) | | | | | | |
| 76.5% | Amount | 31.0 | 31.0 | 31.0 | 31.0 | 31.0 | 28.4 |
| | TiO2 slurry | | | | | | |
| | L746 | | | | | | |
| 100% | Texanol | 4.1 | 4.1 | 4.1 | 4.1 | 4.1 | 3.7 |
| 100% | Water | 10.3 | 8.2 | 6.1 | 1.5 | 0.1 | 0.1 |
| 100% | Antifoam L-475 | 0.41 | 0.41 | 0.41 | 0.41 | 0.41 | 0.41 |
| | Total | 105.8 | 105.7 | 105.7 | 105.7 | 109.6 | 111.9 |
| | Amount (g) | | | | | | |

TABLE 6

| | | Comparative | Inventive | Inventive | Inventive | Inventive | Inventive |
|---|---|---|---|---|---|---|---|
| | Samples | C | 9 | 10 | 11 | 12 | 13 |
| | % PUD in | 0% | 2.5% | 5.0% | 10.0% | 15.0% | 25.0% |
| | blend (dry/dry) | | | | | | |
| Washability | Stains - % Removed ± 10% | | | | | | |
| 200 cycles | crayon | 98 | 98 | 98 | 98 | 98 | 98 |
| w/409 cleaner | | | | | | | |
| | mustard | 50 | 50 | 50 | 50 | 50 | 50 |
| | ketchup | 100 | 100 | 100 | 100 | 100 | 100 |
| | grape juice | 90 | 90 | 100 | 100 | 100 | 100 |
| | pen | 30 | 50 | 20 | 30 | 30 | 30 |
| | marker | 70 | 90 | 70 | 100 | 100 | 100 |
| Block | Rating | | | | | | |
| Resistance | | | | | | | |
| | 1 day Room T | 2 | 3 | 2 | 2 | 4 | 6 |
| | 1 day at 120° F. | 1 | 2 | 1 | 1 | 3 | 5 |
| | 7 days Room T | 5 | 4 | 3 | 5 | 5 | 7 |
| | 7 days at 120° F. | 3 | 3 | 2 | 4 | 4 | 6 |
| K&N Staining | Initial y - value | 94.4 | 94.1 | 93.8 | 94.3 | 93.9 | 93.8 |
| | Final y - value | 89.9 | 91.1 | 90.0 | 90.1 | 91.7 | 89.3 |
| | % Remaining | 4.7 | 3.3 | 4.0 | 4.4 | 2.4 | 4.9 |
| Nigrosine | Initial y - value | 94.3 | 94.22 | 94.31 | 94.4 | 94.14 | 93.87 |
| Staining | | | | | | | |
| Sealed | Final y - value | 92.96 | 92.82 | 93 | 92.98 | 93.11 | 92.73 |
| | % Remaining | 1.42 | 1.49 | 1.39 | 1.50 | 1.09 | 1.21 |
| Nigrosine | Initial y - value | 94.24 | 94.16 | 93.73 | 94.35 | 94.19 | 93.82 |
| Staining | | | | | | | |
| Unsealed | Final y - value | 92.93 | 92.65 | 92.3 | 92.93 | 92.83 | 92.65 |
| | % Remaining | 1.39 | 1.60 | 1.53 | 1.51 | 1.44 | 1.25 |

The above results, shown in Table 6, indicate that block resistance at 25 percent PUD level is significantly improved both at room temperature and 120° F.

### Stain Resistance Test

Stain resistant test method covers the determination of the relative ease of removing common household stains from the dried film of an interior coating by washing with a commercial cleaner.

### Apparatus/Materials:

1. Leneta black plastic charts (scrub charts)
2. 7 mil Dow bar (U-bar)
3. Scrub machine
4. Formula 409 cleaner
5. Staining media
   a) Pencil,
   b) crayon,
   c) pen,
   d) marker,
   e) grape juice,
   f) mustard,
   g) grease
6. Scrub machine sponge
7. Sponge holder

### Procedure:

1. Using the 7 mil Dow drawdown bar drawdown a film onto the Leneta scrub charts.
2. Air dry the charts for 7 days in the CT/CH lab.
3. Place stripes of the household stains across the base coat paint, perpendicular to the scrub path.
4. Allow stains to set 24 hours.
5. Wet sponge and squeeze out excess water.
6. Place panel on scrub machine and place sponge in scrub brush holder (without the brush).
7. Place 15 ml of Formula 409 cleaner on the panel and scrub for 100 cycles.
8. Stop scrub machine and record percent removed for each stain.
9. Add and additional 7 ml of Formula 409 and continue to 200 total cycles.
10. Record the percent removed again of each stain. The test may be continued for further differentiation if necessary, by recording percent removed and adding 7 mL of 409 for every 100 cycles.

### Report:

Record percent removed for first 100 cycles and again at a total of 200 cycles. Continue to do so if the test is continued further than this.

### Variations:

Additional stains for washability can include, but are not limited to the following:
Ketchup
Crayola™ washable marker [specify color, usually black, blue, or red]
Sharpie™ permanent marker [specify colors, usually: black, red, blue]
Highlighter marker, typically yellow
Food coloring [mix of 1 part each of red, green and blue food coloring]
Red oxide colorant [F]
Coffee grounds

Sample can be drawn down vs. the control paint, and visual rating rendered in comparison to control for each of the stains tested.
5=much better than control;
4=better than control;
3=equal to control;
2=worse than control;
1=much worse than control.

### Nigrosine Stain Resistance

Nigrosine stain resistance is a measure of the porosity of a paint film with a water-based stain.

### Apparatus/Materials:

1. Leneta 1B Opacity charts
2. 6 mil Bird bar
3. 2″ paint brush
4. 2 percent Nigrosine solution
5. Hunter colorimeter
6. Wash bottle with room temperature water

### Procedure:

1. Drawdown the test paint with the 6 mil Bird bar on a Leneta 1B Opacity chart.
2. Dry for 2 days.
3. Measure the Y reflectance values twice on the white sealed portion of the Leneta 1B chart and twice on the unsealed part using the Hunter colorimeter.(Make sure reading is on bottom ⅔ of chart)
4. Mark the areas read on the colorimeter.
5. Paint the lower half of the drawdown with the 2 percent Nigrosine solution with the 2″ paint brush. Make sure to paint it on with brush strokes parallel to the direction of the drawdown (same direction) and completely over the bottom ⅔ of the chart.
6. Using a wash bottle, rinse the stain off immediately with room temperature water for 15 seconds
7. Hang the panel vertically for at least 3 hours.
8. After 24 hours recheck the Y reflectance values in the same areas marked on the panel.

Report:

Record average percent retained Y reflectance in the sealed and unsealed areas.

### K&N Stain Resistance

K&N stain resistance test method is a measure of the porosity of the film with oil based stain, according to ASTMD-3258.

### ASTM Reference: ASTM D 3258

### Apparatus/Materials:

1. Leneta 3B Opacity Chart
2. 6 mil Bird drawdown bar
3. 3″, 5 mil Bird drawdown bar
4. K&N Stain
5. Odorless Mineral Spirits
6. Camel Hair Brush
7. Filter paper
8. Hunter colorimeter

### Procedure:

1. Drawdown the test paint and a control paint side by side with the 6 mil Bird bar on the Leneta 3B Opacity chart.
2. Dry 2 days.
3. Measure the Y reflectance values twice on the white section of the panels, marking the areas read on the back.
4. Place the panel with the dry paint film on the drawdown plate.
5. With a 3″ 5 mil Bird bar, draw down the stain perpendicular to the paint film. Be sure to cover the areas where the initial Y reflectance readings were taken.
6. After 5 minutes, wash off the stain by holding the panel vertically and using the camel hair brush wet with odorless mineral spirits.
7. Repeat until most of the stain is removed.
8. Remove any remaining excess stain by applying mineral spirits directly with a wash bottle to the area above the stain.
9. Observe the beads forming at the bottom of the panel and check them with filter paper to be sure that no dye remains.
10. Repeat until beads are clear.
11. Hang panel vertically for at least 3 hours.
12. After 24 hours recheck the Y reflectance of the marked areas on the Hunter colorimeter.

### Report:

Record average percent reflectance retained.

### Block Resistance

Block resistance test method determines the tendency of painted surfaces to stick together (block) when placed in contact with each other under a weighted load, measured in accordance with ASTM D 4964-89.

### Apparatus/Materials:

1. Leneta 3B Opacity Charts
2. 1 lb. square weight
3. Scissors
4. 6 mil bird drawdown bar (3 mil if using paint company standards)

### Procedure:

1. Using the 6 mil (or 3 mil) drawdown bird bar, prepare drawdowns of the test paints on the Leneta 3B Opacity Charts (One paint per chart).
2. Dry the films for 1, 3, and 7 days in the CT/CH lab.
3. At each dry time cut the films into approx. 1″ strips (2 per dry time). With these strips make 3 smaller strips and 3 longer ones. Place the smaller strips down and then the larger ones on top (paint film against paint film).
4. Place the 11b. weight over the films in the CT/CH lab.
5. After 24 hours, remove the weight, separate the strips, and evaluate the block resistance by ASTM D-4946 ratings. For each paint there should be three readings.

### Report:

Record the average of the three readings obtained from the block ratings listed on the next page.

### Block Ratings Chart:

| BLOCK | TYPE OF SEPARATION | PERFORMANCE |
|---|---|---|
| 0 | 75 TO 100% SEAL | VERY POOR |
| 1 | 50 TO 75% SEAL | VERY POOR |
| 2 | 25 TO 50% SEAL | POOR |
| 3 | 5 TO 25% SEAL | POOR |
| 4 | VERY TACKY; NO SEAL | POOR TO FAIR |
| 5 | MODERATE TACK | FAIR |
| 6 | SLIGHT TACK | GOOD |
| 7 | VERY SLIGHT TO SLIGHT | GOOD TO VERY GOOD |
| 8 | VERY SLIGHT; SLIGHT | VERY GOOD |
| | PRESSURE REQUIRED | |
| 9 | TRACE TACK; FALLS APART | EXCELLENT |
| | WHEN SHAKEN | |
| 10 | NO TACK; FALLS APART | PERFECT |

The present invention may be embodied in other forms without departing from the spirit and the essential attributes thereof, and, accordingly, reference should be made to the appended claims, rather than to the foregoing specification, as indicating the scope of the invention.

1. A hybrid dispersion comprising the blending product of:
less than 30 percent by weight of a minor component comprising a hydrophobic polyurethane dispersion derived from one or more natural oil based polyols, based on the weight of the hybrid dispersion; and
less than 100 percent by weight of a major component selected from the group consisting of a latex emulsion, an epoxy, and a polyolefin dispersion;
wherein the hybrid dispersion has a solid content in the range of 10 to 75 percent based on the weight of the hybrid dispersion.

2. A process for producing a hybrid dispersion comprising the steps of:
selecting a minor component comprising a hydrophobic polyurethane dispersion derived from one or more natural oil based polyols;
selecting a major component selected from the group consisting of a latex emulsion, an epoxy, and a polyolefin dispersion;
blending said minor component into said major component;
thereby producing said hybrid dispersion comprising less than 30 percent by weight of the minor component and less than 100 percent by weight of the major component, based on the weight of hybrid dispersion, and wherein said hybrid dispersion has a solid content in the range of 10 to 75 percent based on the weight of the hybrid dispersion.

3. A coated article comprising:
a coating layer associated with one or more surfaces of a substrate, wherein said coating layer is derived from a hybrid dispersion comprising the blending product of;
less than 30 percent by weight of a minor component comprising a hydrophobic polyurethane dispersion derived from one or more natural oil based polyols, based on the weight of the hybrid dispersion; and
less than 100 percent by weight of a major component selected from the group consisting of a latex emulsion, an epoxy, and a polyolefin dispersion;
wherein the hybrid dispersion has a solid content in the range of 10 to 75 percent based on the weight of the hybrid dispersion.

4. (canceled)

5. (canceled)

6. (canceled)

7. The hybrid dispersion according to claim 1, wherein said hybrid dispersion comprises 1 to 25 percent by the dry weight of the solid content of the hydrophobic polyurethane dispersion or 1 to 25 percent by the dry weight of the hydrophobic polyurethane prepolymer.

8. The hybrid dispersion according to claim 1, wherein said hybrid dispersion further comprises one or more fillers, one or more pigments, or one or more additives.
